(19) United States
(12) Patent Application Publication
(10) Pub. No.: US 2021/0391575 A1
(43) Pub. Date: Dec. 16, 2021

(54) POSITIVE ELECTRODE ACTIVE MATERIAL, SECONDARY BATTERY, ELECTRONIC DEVICE, AND VEHICLE

(71) Applicant: SEMICONDUCTOR ENERGY LABORATORY CO., LTD., ATSUGI-SHI, KANAGAWA-KEN (JP)

(72) Inventors: Mayumi MIKAMI, Atsugi, Kanagawa (JP); Ryota TAJIMA, Isehara, Kanagawa (JP)

(21) Appl. No.: 17/290,841

(22) PCT Filed: Nov. 5, 2019
(86) PCT No.: PCT/IB2019/059464

§ 371 Date: May 3, 2021

(30) Foreign Application Priority Data
Nov. 16, 2018 (JP) 2018-215460

(51) Int. Cl. H01M 4/525; H01M 4/505; H01M 10/0525; C01G 51/00; C01G 53/00

(52) U.S. Cl. CPC H01M 4/525; H01M 4/505; H01M 2004/028; C01G 51/50; C01G 53/50; H01M 10/0525

(57) ABSTRACT

A positive electrode active material, which has high capacity and excellent charge and discharge cycle performance, for a lithium-ion secondary battery is provided. The positive electrode active material contains lithium, cobalt, an element X, and fluorine, and includes a region represented by a layered rock-salt structure. The space group of the region is represented by R-3m. The element X is one or more selected from elements that have a property in which ΔE3 obtained by subtracting, from the stabilization energy in the case of substitution of the element at a lithium position in lithium cobalt oxide, the stabilization energy before the substitution is smaller than ΔE4 obtained by subtracting, from the stabilization energy in the case of substitution of the element at a cobalt position in lithium cobalt oxide, the stabilization energy before the substitution. ΔE3 and ΔE4 are calculated by the first-principles calculation.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof In particular, one embodiment of the present invention relates to a positive electrode active material that can be used for a secondary battery, a secondary battery, and an electronic device including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, a demand for lithium-ion secondary batteries with high output and high energy density has rapidly grown with the development of the semiconductor industry, for portable information terminals such as mobile phones, smartphones, tablets, and laptop computers; portable music players; digital cameras; medical equipment; next-generation clean energy vehicles (hybrid electric vehicles (HEV), electric vehicles (EV), plug-in hybrid electric vehicles (PHEV), and the like); and the like. The lithium-ion secondary batteries are essential as rechargeable energy supply sources for today's information society.

The performance required for lithium-ion secondary batteries includes much higher energy density, improved cycle performance, safety under a variety of environments, improved long-term reliability, and the like.

Thus, improvement of a positive electrode active material has been studied to improve the cycle performance and increase the capacity of lithium-ion secondary batteries (Patent Document 1 and Patent Document 2). In addition, a crystal structure of a positive electrode active material also has been studied (Non-Patent Document 1 to Non-Patent Document 3).

X-ray diffraction (XRD) is one of methods used for analysis of a crystal structure of a positive electrode active material. With the use of the ICSD (Inorganic Crystal Structure Database) described in Non-Patent Document 5, XRD data can be analyzed.

In addition, as disclosed in Non-Patent Document 6 and Non-Patent Document 7, the energy depending on the crystal structure of a compound, composition, and the like can be calculated by using the first-principles calculation.

Patent Document 3 discloses an example of performing the first-principles calculation on LiNi₁₋ₓMₓO₂. Patent Document 4 discloses the formation energy of a silicon oxide compound obtained by the first-principles calculation.

### REFERENCE

### Patent Document

[Patent Document 1] Japanese Published Patent Application No. 2002-216760
[Patent Document 2] Japanese Published Patent Application No. 2006-261132
[Patent Document 3] Japanese Published Patent Application No. 2016-091633
[Patent Document 4] PCT International Publication No. WO2011/077654

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16), 2009, 165114.
[Non-Patent Document 3] Zhaohui Chen et al., “Staging Phase Transitions in LiₓCoO₂”, Journal of The Electrochemical Society, 2002, 149 (12) A1604-A1609.
[Non-Patent Document 4] W. E. Counts et al., Journal of the American Ceramic Society, 1953, 36 [1] 12-17. FIG. 01471.
[Non-Patent Document 5] Belsky, A. et al., “New developments in the Inorganic Crystal Structure Database (ICSD): accessibility in support of materials research and design”, Acta Cryst., 2002, B58 364-369.
[Non-Patent Document 6] Dudarev, S. L. et al, “Electron-energy-loss spectra and the structural stability of nickel oxide: An LSDA1U study”, Physical Review B, 1998, 57(3) 1505.
[Non-Patent Document 7] Zhou, F. et al, “First-principles prediction of redox potentials in transition-metal compounds with LDA+U”, Physical Review B, 2004, 70 235121.

### SUMMARY OF THE INVENTION

### Problems to be Solved by the Invention

An object of one embodiment of the present invention is to provide a positive electrode active material, which has high capacity and excellent charge and discharge cycle performance, for a secondary battery. Alternatively, an object is to provide a manufacturing method of a positive electrode active material with high productivity. Another object of one embodiment of the present invention is to provide a positive electrode active material that leads to the suppression of a capacity reduction due to charge and discharge cycles when used for a secondary battery. Another object of one embodiment of the present invention is to provide a high-capacity secondary battery. Another object of one embodiment of the present invention is to provide a secondary battery with excellent charge and discharge characteristics. Another object of one embodiment of the present invention is to provide a highly safe or reliable secondary battery.

Another object of one embodiment of the present invention is to provide a novel material, a novel active material particle, a novel power storage device, or a manufacturing method thereof.

Note that the description of these objects does not preclude the existence of other objects. One embodiment of the present invention does not have to achieve all these objects. Note that other objects can be taken from the description of the specification, the drawings, and the claims.

### Means for Solving the Problems

One embodiment of the present invention is a positive electrode active material containing lithium, cobalt, and an element X, which includes a region represented by a layered rock-salt structure. The space group of the region is represented by R-3m. The element X is one or more selected from elements that have a property in which ΔE3 obtained by subtracting, from the stabilization energy in the case of substitution of the element at a lithium position in LiCoO₂, the stabilization energy before the substitution is smaller than ΔE4 obtained by subtracting, from the stabilization energy in the case of substitution of the element at a cobalt position in LiCoO₂, the stabilization energy before the substitution. ΔE3 and ΔE4 are calculated by the first-principles calculation.

In the above structures, it is preferable in the first-principles calculation that LiCoO₂ have a layered rock-salt structure and be represented by a space group R-3m and that ΔE3 be lower than or equal to 1 eV.

In the above structures, it is preferable that the element X contain one or more selected from calcium, magnesium, and zirconium.

Another embodiment of the present invention is a positive electrode active material containing lithium, cobalt, nickel, manganese, and an element X, which includes a region represented by a layered rock-salt structure. The space group of the region is represented by R-3m. The element X is one or more selected from elements that have a property in which ΔE5 obtained by subtracting, from the stabilization energy in the case of substitution of the element at a lithium position in LiCoₓNi_{y}Mn_{z}O₂, the stabilization energy before the substitution is smaller than ΔE6 that is the smallest value of values obtained by subtracting, from the stabilization energies in the cases of substitution of the element at a cobalt position, a nickel position, and a manganese position in LiCoₓNi_{y}Mn_{z}O₂, the stabilization energies before the substitution. Satisfied is 0.8 <x+y+z<1.2, and y and z are each larger than 0.1 times x and smaller than eight times x. ΔE5 and ΔE6 are calculated by the first-principles calculation.

In the above structure, given that an atomic ratio of cobalt, nickel, and manganese contained in the positive electrode active material is X1:Y1:Z1, it is preferable that X1 be larger than 0.8 times x and smaller than 1.2 times x, Y1 be larger than 0.8 times y and smaller than 1.2 times y, and Z1 be larger than 0.8 times z and smaller than 1.2 times z.

In the above structure, it is preferable in the first-principles calculation that LiCoₓNi_{y}Mn_{z}O₂ have a layered rock-salt structure and be represented by a space group R-3m and that an absolute value of ΔE5 be lower than or equal to 1 eV.

Another embodiment of the present invention is a positive electrode active material containing lithium, nickel, and an element X, which includes a region represented by a layered rock-salt structure. The space group of the region is represented by R-3m. The element X is one or more selected from elements that have a property in which ΔE7 obtained by subtracting, from the stabilization energy in the case of substitution of the element at a lithium position in LiNiO₂, the stabilization energy before the substitution is smaller than ΔE8 obtained by subtracting, from the stabilization energy in the case of substitution of the element at a nickel position in LiCoₓNi_{y}Mn_{z}O₂, the stabilization energy before the substitution. ΔE7 and ΔE8 are calculated by the first-principles calculation.

In the above structure, it is preferable in the first-principles calculation that LiNiO₂ have a layered rock-salt structure and be represented by a space group R-3m and that ΔE7 be lower than or equal to 1 eV.

In the above structures, it is preferable in the first-principles calculation that the element X be substituted at the lithium position or the cobalt position in the proportion of one or less of the element X to 54 oxygen.

In the above structures, it is preferable that, in the positive electrode active material, the concentration of the element X detected by X-ray photoelectron spectroscopy be greater than or equal to 0.4 and less than or equal to 1.5 when the sum of the concentrations of cobalt, nickel, and manganese detected by X-ray photoelectron spectroscopy is 1.

In the above structures, the positive electrode active material preferably contains fluorine.

In the above structures, it is preferable that the positive electrode active material contain phosphorus and that the number of phosphorus atoms be larger than or equal to 0.01 times the sum of the number of cobalt, nickel, and manganese atoms and smaller than or equal to 0.12 times the sum in the positive electrode active material.

In the above structures, the positive electrode active material preferably has diffraction peaks at 2θ=19.30±0.20° and 2θ=45.55±0.10° when a secondary battery using the positive electrode active material for a positive electrode and a lithium metal for a negative electrode is subjected to constant current charging under 25° C. environment until battery voltage becomes 4.6 V and then subjected to constant voltage charging until a current value becomes 0.01 C, and then the positive electrode is analyzed by powder X-ray diffraction using a CuKα1 ray.

Another embodiment of the present invention is a secondary battery including a positive electrode in which a positive electrode active material layer including any of the above positive electrode active materials is positioned over a current collector, and a negative electrode.

Another embodiment of the present invention is an electronic device including the secondary battery described above and a display portion.

Another embodiment of the present invention is a vehicle including the secondary battery described above and an electric motor.

### Effect of the Invention

According to one embodiment of the present invention, a positive electrode active material, which has high capacity and excellent charge and discharge cycle performance, for a secondary battery, and a manufacturing method thereof can be provided. In addition, a manufacturing method of a positive electrode active material with high productivity can be provided. In addition, a positive electrode active material that leads to the suppression of a capacity reduction due to charge and discharge cycles when used for a secondary battery can be provided. In addition, a high-capacity secondary battery can be provided. In addition, a secondary battery with excellent charge and discharge characteristics can be provided. In addition, a highly safe or reliable secondary battery can be provided. In addition, a novel material, a novel active material particle, a novel power storage device, or a manufacturing method thereof can be provided.

### BRIEF DESCRIPTION OF THE DRAWINGS

FIG. 1 is a diagram illustrating the depth of charge and crystal structures of a positive electrode active material of one embodiment of the present invention.

FIG. 2 is a diagram illustrating the depth of charge and crystal structures of a conventional positive electrode active material.

FIG. 3 shows XRD patterns calculated from crystal structures.

FIG. 4A is a diagram illustrating a crystal structure of a positive electrode active material of one embodiment of the present invention. FIG. 4B shows the magnetism of a positive electrode active material of one embodiment of the present invention.

FIG. 5A is a diagram illustrating a crystal structure of a conventional positive electrode active material. FIG. 5B shows the magnetism of a conventional positive electrode active material.

FIG. 6 illustrates an example of a formation method of a positive electrode active material of one embodiment of the present invention.

FIG. 7A is a cross-sectional view of an active material layer when a graphene compound is used as a conductive additive. FIG. 7B is a cross-sectional view of an active material layer when a graphene compound is used as a conductive additive.

FIG. 8A illustrates a charging method of a secondary battery. FIG. 8B illustrates a charging method of a secondary battery. FIG. 8C shows an example of a secondary battery voltage and a charging current.

FIG. 9A illustrates a charging method of a secondary battery. FIG. 9B illustrates a charging method of a secondary battery. FIG. 9C illustrates a charging method of a secondary battery. FIG. 9D shows an example of a secondary battery voltage and a charging current.

FIG. 10 shows an example of a secondary battery voltage and a discharging current.

FIG. 11A illustrates a coin-type secondary battery. FIG. 11B illustrates a coin-type secondary battery. FIG. 11C illustrates charging of a secondary battery.

FIG. 12A illustrates a cylindrical secondary battery. FIG. 12B illustrates a cylindrical secondary battery. FIG. 12C illustrates a plurality of secondary batteries. FIG. 12D illustrates a plurality of secondary batteries.

FIG. 13A illustrates an example of a battery pack. FIG. 13B illustrates an example of a battery pack.

FIG. 14A illustrates an example of a battery pack. FIG. 14B illustrates an example of a battery pack. FIG. 14C illustrates an example of a battery pack. FIG. 14D illustrates an example of a battery pack.

FIG. 15A illustrates an example of a secondary battery. FIG. 15B illustrates an example of a secondary battery.

FIG. 16 illustrates an example of a wound body.

FIG. 17A illustrates a structure of a laminated secondary battery. FIG. 17B illustrates a laminated secondary battery. FIG. 17C illustrates a laminated secondary battery.

FIG. 18A illustrates a laminated secondary battery. FIG. 18B illustrates a laminated secondary battery.

FIG. 19 is an external view of a secondary battery.

FIG. 20 is an external view of a secondary battery.

FIG. 21A illustrates an example of a positive electrode and an example of a negative electrode. FIG. 21B illustrates a manufacturing method of a secondary battery. FIG. 21C illustrates a manufacturing method of a secondary battery.

FIG. 22A illustrates a bendable secondary battery. FIG. 22B illustrates a bendable secondary battery. FIG. 22C illustrates a bendable secondary battery. FIG. 22D illustrates a bendable secondary battery. FIG. 22E illustrates a bendable secondary battery.

FIG. 23A illustrates a bendable secondary battery. FIG. 23B illustrates a bendable secondary battery.

FIG. 24A illustrates an example of an electronic device. FIG. 24B illustrates an example of an electronic device. FIG. 24C illustrates an example of an electronic device. FIG. 24D illustrates an example of an electronic device. FIG. 24E illustrates an example of a secondary battery. FIG. 24F illustrates an example of an electronic device. FIG. 24G illustrates an example of an electronic device. FIG. 24H illustrates an example of an electronic device.

FIG. 25A illustrates an example of an electronic device. FIG. 25B illustrates an example of an electronic device. FIG. 25C illustrates a charge control circuit.

FIG. 26 illustrates examples of electronic devices.

FIG. 27A illustrates an example of a vehicle. FIG. 27B illustrates an example of a vehicle. FIG. 27C illustrates an example of a vehicle.

FIG. 28A shows energy calculation results. FIG. 28B shows energy calculation results. FIG. 28C shows energy calculation results.

FIG. 29A shows energy calculation results. FIG. 29B shows energy calculation results. FIG. 29C shows energy calculation results.

FIG. 30A shows energy calculation results. FIG. 30B shows energy calculation results. FIG. 30C shows energy calculation results.

FIG. 31A shows energy calculation results. FIG. 31B shows energy calculation results. FIG. 31C shows energy calculation results.

FIG. 32A shows energy calculation results. FIG. 32B shows energy calculation results. FIG. 32C shows energy calculation results.

FIG. 33A shows energy calculation results. FIG. 33B shows energy calculation results. FIG. 33C shows energy calculation results.

FIG. 34A shows energy calculation results. FIG. 34B shows energy calculation results.

### MODE FOR CARRYING OUT THE INVENTION

Hereinafter, embodiments of the present invention will be described in detail using the drawings. Note that the present invention is not limited to the description below, and it is easily understood by those skilled in the art that modes and details thereof can be modified in various ways. In addition, the present invention should not be construed as being limited to the description in the following embodiments.

In addition, in this specification and the like, crystal planes and orientations are indicated by the Miller indices. In the crystallography, a bar is placed over a number in the expression of crystal planes and orientations; however, in this specification and the like, crystal planes and orientations are in some cases expressed by placing − (a minus sign) before a number instead of placing a bar over the number because of patent expression limitations. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region from a surface to a depth of approximately 10 nm. A plane generated by a crack may also be referred to as a surface. In addition, a region which is located at a deeper portion than the surface portion is referred to as an inner portion.

In this specification and the like, a layered rock-salt crystal structure of a composite oxide containing lithium and a transition metal refers to a crystal structure which has rock-salt ion arrangement where cations and anions are alternately arranged and in which lithium can be two-dimensionally diffused owing to formation of a two-dimensional plane by regular arrangement of the transition metal and lithium. Note that a defect such as a cation or anion vacancy may exist. Moreover, strictly speaking, a lattice of a rock-salt crystal is distorted in the layered rock-salt crystal structure in some cases.

In addition, in this specification and the like, a rock-salt crystal structure refers to a structure in which cations and anions are alternately arranged. Note that a cation or anion vacancy may exist.

In addition, in this specification and the like, a pseudo-spinel crystal structure of a composite oxide containing lithium and a transition metal refers to a space group R-3m, which is not a spinel crystal structure but a crystal structure in which an ion of cobalt, magnesium, or the like is coordinated to six oxygen atoms, and the cation arrangement has symmetry similar to that of the spinel crystal structure. Note that in the pseudo-spinel crystal structure, an ion of a light element such as lithium is coordinated to four oxygen atoms in some cases. Also in that case, the ion arrangement has symmetry similar to that of the spinel crystal structure.

The pseudo-spinel crystal structure can also be regarded as a crystal structure that contains Li between layers at random but is similar to a CdCl₂-type crystal structure. The crystal structure similar to the CdCl₂-type crystal structure is close to a crystal structure of lithium nickel oxide when charged up to a depth of charge of 0.94 (Li_{0.06}NiO₂); however, pure lithium cobalt oxide or a layered rock-salt positive electrode active material containing a large amount of cobalt is known not to have this crystal structure generally.

In the layered rock-salt crystal and the rock-salt crystal, the anion arrangement is a cubic close-packed structure (a face-centered cubic lattice structure). It is assumed that the anion arrangement is a cubic close-packed structure also in the pseudo-spinel crystal. When these are in contact with each other, there is a crystal plane at which orientations of cubic close-packed structures composed of anions are aligned. Note that the space groups of the layered rock-salt crystal and the pseudo-spinel crystal are R-3m, which is different from the space groups of the rock-salt crystal, Fm-3m (the space group of a general rock-salt crystal) and Fd-3m (the space group of a rock-salt crystal having the simplest symmetry); thus, the Miller indices of the crystal plane satisfying the above conditions in the layered rock-salt crystal and the pseudo-spinel crystal are different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

Whether the crystal orientations in two regions are substantially aligned can be judged from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, and the like. X-ray diffraction (XRD), electron diffraction, neutron diffraction, and the like can also be used for judging. In the TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In addition, in this specification and the like, theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In addition, in this specification and the like, depth of charge obtained when all lithium that can be inserted and extracted is inserted is 0, and depth of charge obtained when all lithium that can be inserted and extracted and is contained in a positive electrode active material is extracted is 1.

In addition, in this specification and the like, charging refers to transfer of lithium ions from a positive electrode to a negative electrode in a battery and transfer of electrons from the negative electrode to the positive electrode in an external circuit. For a positive electrode active material, extraction of lithium ions is called charging. Moreover, a positive electrode active material with a depth of charge of greater than or equal to 0.74 and less than or equal to 0.9, more specifically, a depth of charge of greater than or equal to 0.8 and less than or equal to 0.83 is referred to as a high-voltage charged positive electrode active material. Thus, for example, LiCoO₂ charged to 219.2 mAh/g is a high-voltage charged positive electrode active material. In addition, LiCoO₂ that is subjected to constant current charging in an environment at 25° C. and a charging voltage of higher than or equal to 4.525 V and lower than or equal to 4.65 V (in the case of a lithium counter electrode), and then subjected to constant voltage charging until the current value becomes 0.01 C or approximately ⅕ to 1/100 of the current value at the time of the constant current charging is also referred to as a high-voltage charged positive electrode active material.

Similarly, discharging refers to transfer of lithium ions from a negative electrode to a positive electrode in a battery and transfer of electrons from the positive electrode to the negative electrode in an external circuit. For a positive electrode active material, insertion of lithium ions is called discharging. Furthermore, a positive electrode active material with a depth of charge of less than or equal to 0.06 or a positive electrode active material from which more than or equal to 90% of the charge capacity is discharged from a state where the positive electrode active material is charged with high voltage is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In addition, in this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

### Embodiment 1

In this embodiment, a positive electrode active material and the like of one embodiment of the present invention are described.

### [Structure of Positive Electrode Active Material]

In a positive electrode material containing a metal (hereinafter referred to as an element A) serving as a carrier ion, an ion of the metal is extracted from the positive electrode material due to charging. A larger amount of the extracted element A means a larger amount of ions contributing to the capacity of a secondary battery, increasing the capacity. However, a large amount of the extracted element A easily causes collapse of the crystal structure of a compound contained in the positive electrode material. The collapse of the crystal structure of the positive electrode material sometimes decreases the discharge capacity with charge and discharge cycles. As the element A, an alkaline metal such as lithium, sodium, or potassium or a Group 2 element such as calcium, beryllium, or magnesium can be used, for example.

The positive electrode material of one embodiment of the present invention contains an element (hereinafter, an element X) that is easily substituted at an element A position; thus, the collapse of the crystal structure due to extraction of the element A can be inhibited in a compound contained in the positive electrode material. The element X will be described in detail later. For example, an element such as magnesium, calcium, zirconium, lanthanum, or barium can be used as the element X. For another example, an element such as copper, potassium, sodium, or zinc can be used as the element X. Two or more of the elements described above as the element X may be combined and used.

Here, substitution at a position of an atom in a crystal of a positive electrode material is expressed as substitution at a site of an atom in some cases.

It is preferable that the positive electrode material of one embodiment of the present invention contain a metal (hereinafter, an element M) whose valence number changes due to charging and discharging of a secondary battery. The element M is a transition metal, for example. The positive electrode material of one embodiment of the present invention preferably contains one or more of cobalt, nickel, and manganese, particularly cobalt, as the element M, for example. The positive electrode material may contain, at an element M position, an element with no valence change that can have the same valence as the element M, such as aluminum, specifically a trivalent representative element, for example.

For example, in the case where cobalt, nickel, and manganese are contained as the element M, the number of nickel atoms is preferably larger than 0.1 times the sum of the number of cobalt, nickel, and manganese atoms and smaller than eight times the sum. The number of manganese atoms is preferably larger than 0.1 times the sum of the number of cobalt, nickel, and manganese atoms and smaller than eight times the sum.

Alternatively, in the case where cobalt, nickel, and manganese are contained as the element M, for example, the number of nickel atoms is preferably larger than 0.1 times the number of cobalt atoms and smaller than eight times the number of cobalt atoms. The number of manganese atoms is preferably larger than 0.1 times the number of cobalt atoms and smaller than eight times the number of cobalt atoms.

Alternatively, in the case where cobalt, nickel, and manganese are contained as the element M, for example, the number of nickel atoms is smaller than 0.25 times the sum of the number of cobalt, nickel, and manganese atoms. Alternatively, the number of nickel atoms is larger than 0.5 times the sum of the number of cobalt, nickel, and manganese atoms and smaller than 0.6 times the sum. Alternatively, the number of nickel atoms is larger than 0.73 times the sum of the number of cobalt, nickel, and manganese atoms.

Alternatively, in the case where cobalt, nickel, and manganese are contained as the element M, for example, the number of nickel atoms is larger than 0.1 times the number of cobalt atoms and smaller than 0.43 times the number of cobalt atoms. Alternatively, in the case where cobalt, nickel, and manganese are contained as the element M, for example, the number of nickel atoms is larger than 6.5 times the number of cobalt atoms.

Alternatively, in the case where cobalt, nickel, and manganese are contained as the element M, for example, the number of manganese atoms is smaller than 0.25 times the number of cobalt atoms.

The positive electrode material of one embodiment of the present invention contains an oxide containing the element A and the element M, for example. The positive electrode material of one embodiment of the present invention contains an oxide that can be represented by a chemical formula AM_{y}O_{z} (y>0, z>0), for example.

In the compound contained in the positive electrode material of one embodiment of the present invention, it is further preferable that the compound be represented by a chemical formula AM_{y}O_{z} (y>0, z>0) and have a layered rock-salt crystal structure. Moreover, the compound is preferably represented by a space group R-3m.

In the compound contained in the positive electrode material of one embodiment of the present invention, it is preferable that the element X be more easily substituted at the element A position than at the element M position.

The stabilities of the compounds after the element X is substituted at the element A position and after the element X is substituted at the element M position can be estimated by the difference between the total energy of the system before substitution and that after substitution obtained by the first-principles calculation, for example. Here, a value obtained by subtracting, from the energy after substitution of the element X at the element A position, the energy before the substitution is represented by ΔE1. A value obtained by subtracting, from the energy after substitution of the element X at the element M position, the energy before the substitution is represented by ΔE2. In the case where ΔE1 is smaller than ΔE2, it is suggested that the element X is more easily substituted at the element A position than at the element M position.

A larger value of ΔE1 indicates a larger energy required for substitution. In the case where the energy required for substitution is large, for example, a reaction temperature needs to be high in some cases. Here, in the first-principles calculation described in this specification, 1 eV corresponds to approximately 10000 K. With this value used as a reference, ΔE1 is preferably lower than or equal to 2.5 eV, further preferably lower than or equal to 1 eV, for example. Note that 10000 K shown above is merely a rough reference value; the energy actually required for substitution is presumably lower than the temperature obtained by the first-principles calculation in the case where a crystal includes a defect, or in the case where decrease in melting point occurs due to the effect of halogen or the like described later, for example.

In the case where ΔE1 is a positive value, the element X is unstable in some cases even after being substituted in the compound represented by AM_{y}O_{z}. In such a case, for example, it is suggested that the element X, which is substituted to enter the compound represented by AM_{y}O_{z}, easily goes out of the compound. Thus, in such a case, for example, at least part of the outer surface of the compound represented by AM_{y}O_{z} is covered with a compound containing the element X in some cases. Covering probably inhibits a capacity reduction due to charging and discharging of a secondary battery. Furthermore, the element X is deposited on the outer surface of the compound represented by AM_{y}O_{z} in some cases, for example. Alternatively, in the positive electrode active material, a compound containing a large amount of the element X and a compound in which a small amount of the element X is dissolved in the compound represented by AM_{y}O_{z} to form a solid solution are phase-separated in some cases.

In the case where ΔE1 is a negative value, it is suggested that the crystal structure of a compound contained in the positive electrode material after substitution is stable and that a larger absolute value of ΔE1 enables a more stable crystal structure. In addition, in the case where ΔE1 is a negative value, substitution is more easily caused even when a reaction is caused at a low temperature than in the case where ΔE1 is a positive value.

The ion radius of the element X is preferably substantially similar to or larger than the ion radius of the element M or the element A, for example.

With the use of the positive electrode material of one embodiment of the present invention, the capacity of a secondary battery is increased and a discharge capacity reduction due to charge and discharge cycles is inhibited.

### <Positive Electrode Active Material>

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The positive electrode active material of one embodiment of the present invention is an oxide containing lithium and cobalt, for example. The positive electrode active material of one embodiment of the present invention is represented by a space group R-3m, for example. As described in detail below, the positive electrode active material of one embodiment of the present invention contains the element X, whereby a deviation of layers containing cobalt and oxygen can be inhibited even when the depth of charge becomes larger, for example.

The positive electrode active material of one embodiment of the present invention preferably has a pseudo-spinel structure that is described later, particularly when the depth of charge is large.

Furthermore, the positive electrode active material of one embodiment of the present invention preferably contains halogen such as fluorine or chlorine in addition to the element X When the positive electrode active material of one embodiment of the present invention contains the halogen, substitution of the element X at the element A position is promoted in some cases.

### <First-Principles Calculation>

An example of a method for calculating ΔE1 and ΔE2 shown above using the first-principles calculation is described below.

ΔE1 is a value obtained by subtracting, from the energy after substitution of the element X at the element A position, the energy before the substitution, and can be expressed by the following (Formula 1), for example.

[Formula 1]

ΔE1={E(t_all)+E(atom_X)}−{E(t_X−A)+E(atom_A)} (Formula 1)

ΔE2 is a value obtained by subtracting, from the energy after substitution of the element X at the element M position, the energy before the substitution, and can be expressed by the following Formula (2), for example.

[Formula 2]

ΔE2={E(t_all)+E(atom_X)}−{E(t_X−M)+E(atom_M)} Formula (2)

Here, E(t_all) represents the total energy of a crystal model subjected to calculation; E(t_X−A) represents the total energy of a crystal model in the case where one atom of the element X is substituted for one atom of the element A in E(t_all); and E(t_X−M) represents the total energy of a crystal model in the case where one atom of the element X is substituted for one atom of the element M in E(t_all). Furthermore, E(atom_A) represents the energy of one atom of the element A, E(atom_X) represents the energy of one atom of the element X, and E(atom_M) represents the energy of one atom of the element M.

Each energy is calculated on the basis that the crystal structure is a layered rock-salt structure, the space group is R-3m, and the lattice and the atomic positions are optimized using the first-principles calculation.

An example of the result of the first-principles calculation is shown below.

As software, VASP (The Vienna Ab initio simulation package) was used. As a functional, GGA (Generalized-Gradient-Approximation)+U was used. The U potentials of elements are shown in Table 1. As for elements whose values are not shown, calculation was conducted without using the U potentials. A potential generated by a PAW (Projector Augmented Wave) method was used as the pseudpotential. The cut-off energy was set to 520 eV. Here, Non-Patent Document 6 and Non-Patent Document 7 can be referred to for the U potential.

In this specification and the like, the energy obtained in this way is referred to as stabilization energy.

In the compound AM_{y}O_{z}, A was lithium, M was cobalt, nickel, and manganese, y=1, and z=2. As for the numbers of atoms used in the calculation, the element A was 27 atoms, the element M was 27 atoms, and oxygen was 54 atoms in the crystal structure before substitution of the element X. The first-principles calculation was performed on compounds with nine conditions of the ratio of nickel to cobalt and manganese in the element M shown in Table 2. Condition 1 shown in Table 2 is LiCoO₂, and Condition 8 is LiNiO₂.

TABLE 1

| | |
|---|---|
| Co | 4.91 |
| Ni | 6.7 |
| Mn | 4.64 |
| Na | — |
| Mg | — |
| K | — |
| Ca | — |
| Ba | — |
| Al | — |
| Si | — |
| P | — |
| S | — |
| Ti | — |
| V | 3.1 |
| Ga | — |
| La | — |
| Fe | 5.3 |
| Cu | 4 |
| Zn | — |
| Ge | — |
| Zr | — |
| Mo | 4.38 |
| Ta | 2 |

TABLE 2

| | |
|---|---|
| Condition 1 | Ni:Co:Mn = 0:9:0 |
| Condition 2 | Ni:Co:Mn = 0:8:1 |
| Condition 3 | Ni:Co:Mn = 1:7:1 |
| Condition 4 | Ni:Co:Mn = 2:5:2 |
| Condition 5 | Ni:Co:Mn = 1:1:1 |
| Condition 6 | Ni:Co:Mn = 5:2:2 |
| Condition 7 | Ni:Co:Mn = 7:1:1 |
| Condition 8 | Ni:Co:Mn = 9:0:0 |
| Condition 9 | Ni:Co:Mn = 3:1:5 |

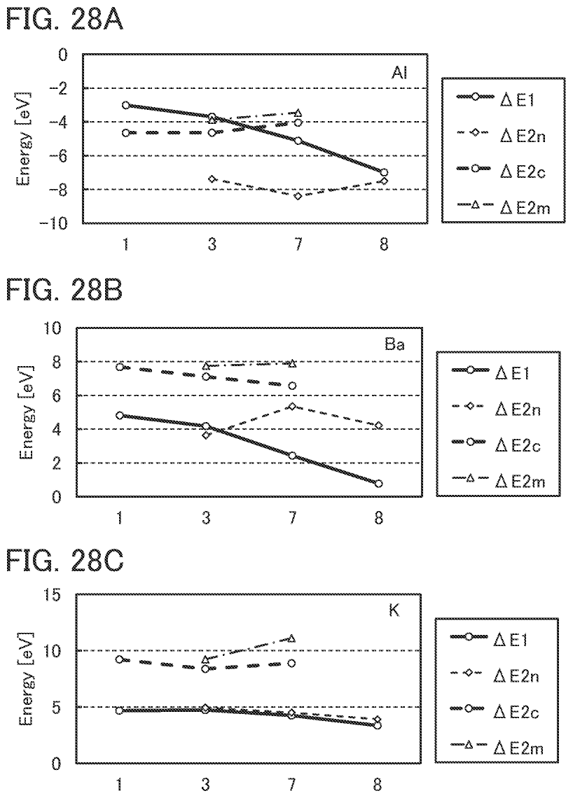

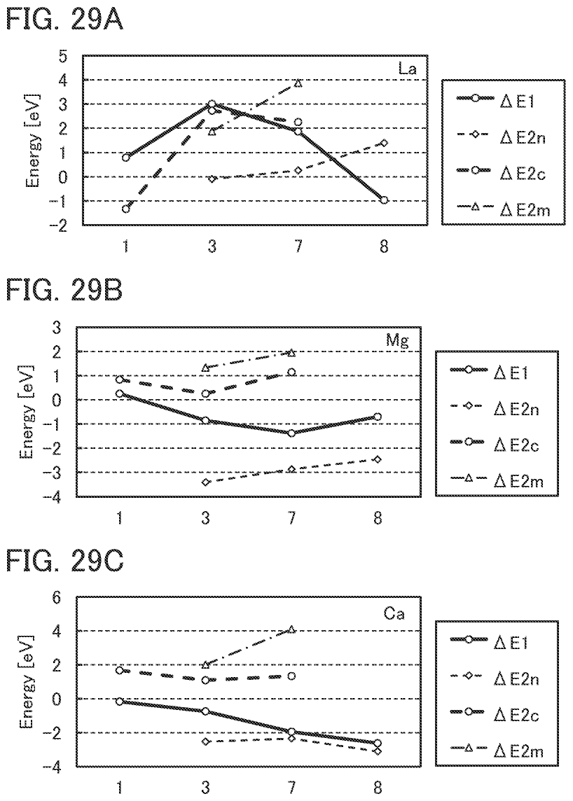

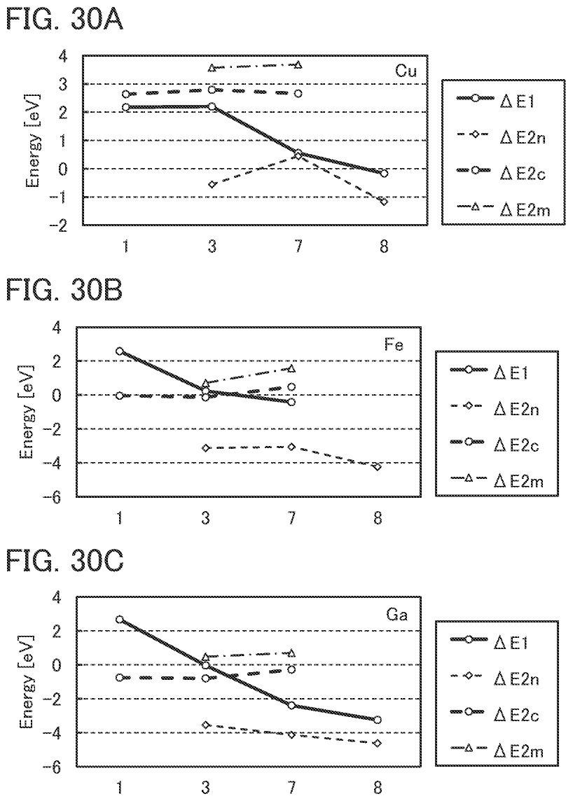

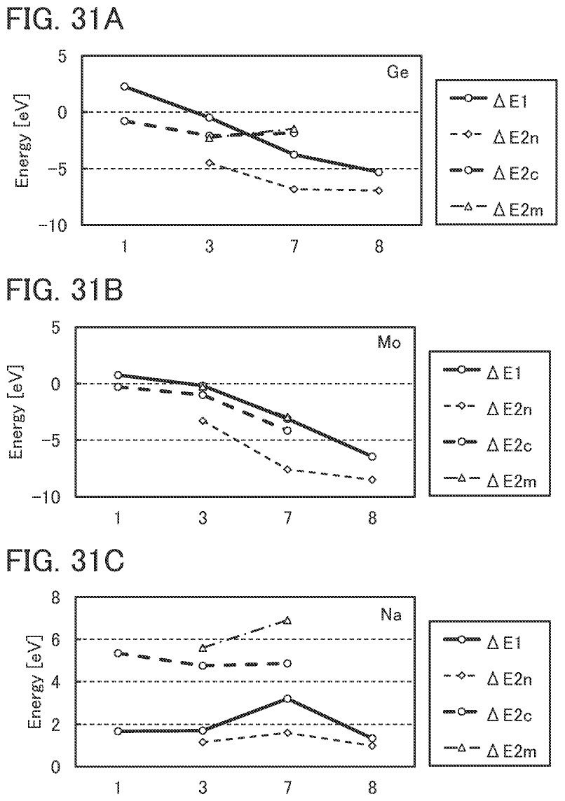

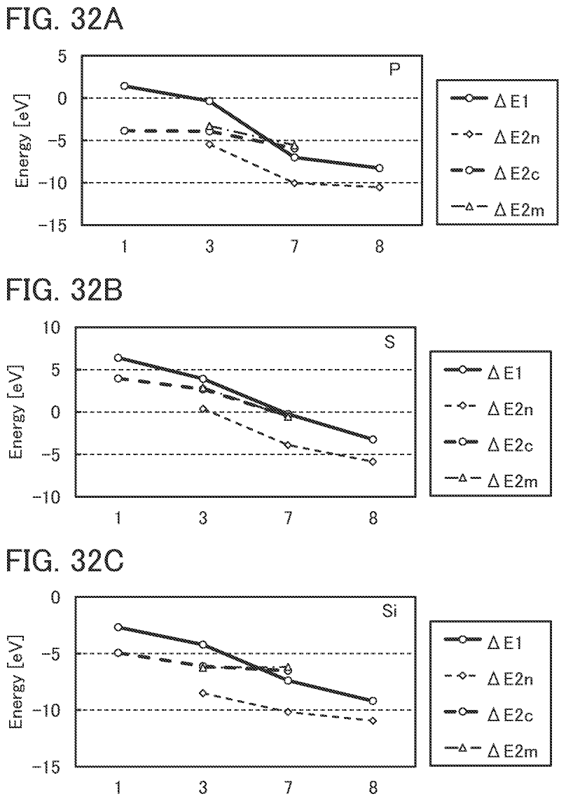

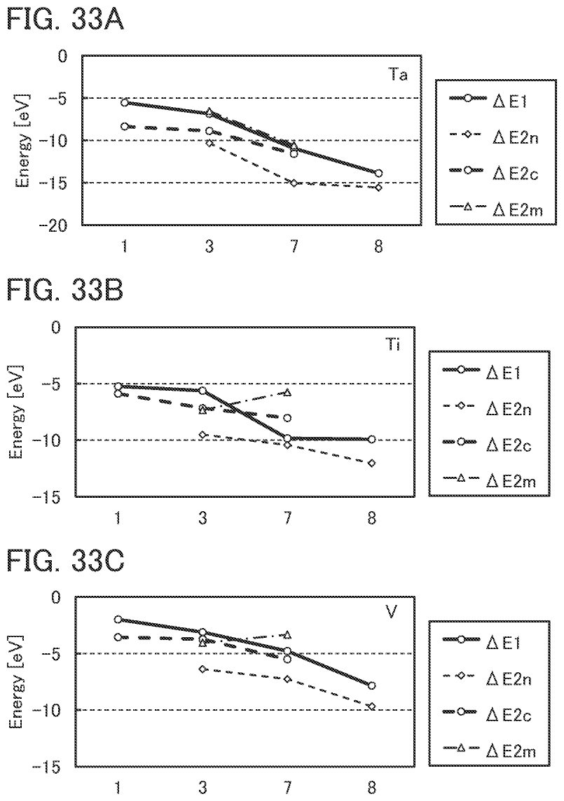

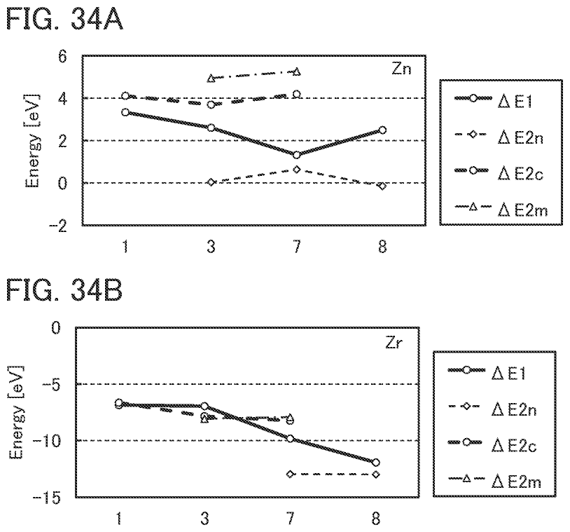

FIG. 28 to FIG. 34 show the result of calculating ΔE1 and ΔE2 by the first-principles calculation under Condition 1, Condition 3, Condition 7, and Condition 8. In each graph, the condition numbers are shown on the horizontal axis and the vertical axis represents energy. FIG. 28A shows the results of aluminum, FIG. 28B shows those of barium, FIG. 28C shows those of potassium, FIG. 29A shows those of lanthanum, FIG. 29B shows those of magnesium, FIG. 29C shows those of calcium, FIG. 30A shows those of copper, FIG. 30B shows those of iron, FIG. 30C shows those of gallium, FIG. 31A shows those of germanium, FIG. 31B shows those of molybdenum, FIG. 31C shows those of sodium, FIG. 32A shows those of phosphorus, FIG. 32B shows those of sulfur, FIG. 32C shows those of silicon, FIG. 33A shows those of tantalum, FIG. 33B shows those of titanium, FIG. 33C shows those of vanadium, FIG. 34A shows those of zinc, and FIG. 34B shows those of zirconium. Note that as for ΔE2, the energy corresponding to substitution at a cobalt position is represented by ΔE2c, the value corresponding to substitution at a nickel position is represented by ΔE2n, and the value corresponding to substitution at a manganese position is represented by ΔE2m.

Table 3 shows the elements X with which ΔE1 is smaller than ΔE2 under the conditions shown in Table 2.

TABLE 3

| | |
|---|---|
| Condition 1 | Ba, Ca, Cu, K, Mg, Na, Zn, Zr |
| Condition 2 | Ba, Ca, Cu, K, La, Na, Zn |
| Condition 3 | K |
| Condition 4 | K |
| Condition 5 | La |
| Condition 6 | Ba, K |
| Condition 7 | Ba, K |
| Condition 8 | Ba, K, La |
| Condition 9 | — |

Among the elements X shown in Table 3, the elements X having an absolute value of ΔE1 of 2.5 eV or lower are shown in Table 4, and the elements X having an absolute value of ΔE1 of 1 eV or lower are shown in Table 5. Among the elements X shown in Table 3, the elements X having ΔE1 of a positive value are shown in Table 6.

TABLE 4

| | |
|---|---|
| Condition 1 | Ca, Cu, Mg, Na |
| Condition 2 | Ca, Cu, La, Na, Zn |
| Condition 3 | — |
| Condition 4 | — |
| Condition 5 | — |
| Condition 6 | Ba |
| Condition 7 | Ba |
| Condition 8 | Ba, La |
| Condition 9 | — |

TABLE 5

| | |
|---|---|
| Condition 1 | Ca, Mg, Zr |
| Condition 2 | Ca, La |
| Condition 3 | — |
| Condition 4 | — |
| Condition 5 | — |
| Condition 6 | — |
| Condition 7 | — |
| Condition 8 | Ba, La |
| Condition 9 | — |

TABLE 6

| | |
|---|---|
| Condition 1 | Ba, Cu, K, Mg, Na, Zn |
| Condition 2 | Ba, Cu, K, Na, Zn |
| Condition 3 | K |
| Condition 4 | K |
| Condition 5 | La |
| Condition 6 | Ba, K |
| Condition 7 | Ba, K |
| Condition 8 | Ba, K |
| Condition 9 | — |

For example, in the case of AM_{y}O_{z} (y>0, z>0) containing the element X shown in Table 4 to Table 6, having a layered rock-salt crystal structure, and being represented by the space group R-3m, a deviation of layers containing the element M is inhibited in a charged state in some cases, which is preferable.

As a specific example, a deviation of CoO₂ layers in the case where y=1, z=2, the element M is cobalt, and the element X is magnesium is described below in detail.

### <Example of Positive Electrode Active Material>

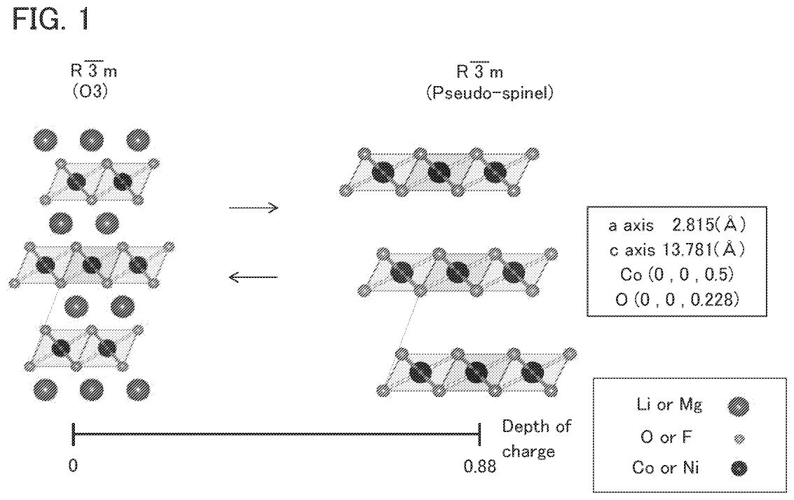

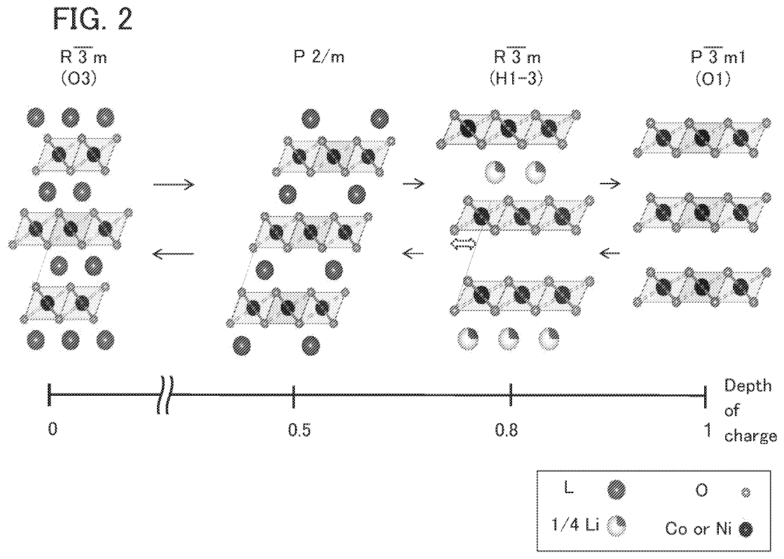

FIG. 1 illustrates, as an example of the positive electrode active material of one embodiment of the present invention, a positive electrode active material 100 that is a positive electrode active material containing lithium as the element A, magnesium as the element X, and cobalt as the element M. FIG. 2 illustrates LiCoO₂ as a typical example of a positive electrode active material not containing the element X.

Although an example of the case where the element M is cobalt is described below, nickel may be contained in addition to cobalt, for example. In that case, the proportion of nickel atoms (Ni) in the sum of cobalt atoms and nickel atoms (Co+Ni) (Ni/(Co+Ni)) is preferably less than 0.1, further preferably less than or equal to 0.075.

When a high-voltage charged state is held for a long time, a transition metal dissolves in an electrolyte solution from the positive electrode active material, and the crystal structure might be broken. However, when nickel is contained at the above proportion, dissolution of the transition metal from the positive electrode active material 100 can be inhibited in some cases.

The addition of nickel decreases charging and discharging voltages, and thus, charging and discharging can be executed at a lower voltage in the case of the same capacity. As a result, dissolution of the transition metal and decomposition of the electrolyte solution might be inhibited. Here, the charging and discharging voltages are, for example, voltages within the range from a depth of charge of 0 to a predetermined depth of charge.

As described in Non-Patent Document 1, Non-Patent Document 2, and the like, the crystal structure of lithium cobalt oxide LiCoO₂, which is one of the conventional positive electrode active materials, changes depending on the depth of charge. FIG. 2 illustrates typical crystal structures of lithium cobalt oxide.

As illustrated in FIG. 2, lithium cobalt oxide with a depth of charge of 0 (in the discharged state) includes a region having the crystal structure of the space group R-3m, and includes three CoO₂ layers in a unit cell. Thus, this crystal structure is referred to as an 03-type crystal structure in some cases. Note that the CoO₂ layer has a structure in which octahedral geometry with oxygen atoms hexacoordinated to cobalt continues on a plane in the edge-sharing state.

Furthermore, when the depth of charge is 1, lithium cobalt oxide has the crystal structure of a space group P-3m1, and one CoO₂ layer exists in a unit cell. Thus, this crystal structure is referred to as an O1-type crystal structure in some cases.

Moreover, lithium cobalt oxide when the depth of charge is approximately 0.88 has the crystal structure of the space group R-3m. This structure can also be regarded as a structure in which CoO₂ structures such as P-3m1(O1) and LiCoO₂ structures such as R-3m(O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 2, the c-axis of the H1-3 type crystal structure is half that of the unit cell for easy comparison with the other structures.

When high-voltage charging with a depth of charge of approximately 0.88 or more and discharging are repeated, the crystal structure of lithium cobalt oxide repeatedly changes between the H1-3 type crystal structure and the R-3m(O3) structure in the discharged state (i.e., an unbalanced phase change).

However, there is a large deviation of the CoO₂ layer between these two crystal structures. As indicated by dotted lines and arrows in FIG. 2, the CoO₂ layer in the H1-3 type crystal structure largely shifts from that in the R-3m(O3) structure. Such a dynamic structural change might adversely affect the stability of the crystal structure.

A difference in volume is also large. A difference in volume in comparison with the same number of cobalt atoms between the H1-3 type crystal structure and the O3-type crystal structure in the discharged state is 3.5% or more.

In addition, a structure in which CoO₂ layers are arranged in a successive manner, as in P-3m1(O1), included in the H1-3 type crystal structure is highly likely to be unstable.

Thus, the repeated high-voltage charging and discharging break the crystal structure of lithium cobalt oxide. The break of the crystal structure degrades the cycle performance. This is probably because the break of the crystal structure reduces sites where lithium can stably exist and makes it difficult to insert and extract lithium.

By contrast, in the positive electrode active material 100 of one embodiment of the present invention, there is a small difference in change in the crystal structure and volume in comparison with the same number of transition metal atoms between the sufficiently discharged state and the high-voltage charged state.

FIG. 1 illustrates the crystal structures of the positive electrode active material 100 before and after being charged and discharged. The positive electrode active material 100 is a composite oxide containing lithium, cobalt, and oxygen. In addition to the above, the positive electrode active material 100 preferably contains magnesium. Furthermore, the positive electrode active material 100 preferably contains halogen such as fluorine or chlorine.

The crystal structure with a depth of charge of 0 (in the discharged state) in FIG. 1 belongs to R-3m(O3) as in FIG. 2. By contrast, the positive electrode active material 100 of one embodiment of the present invention has a crystal with a structure different from that in FIG. 2 when it is sufficiently charged and has a depth of charge of approximately 0.88. Note that although the indication of lithium is omitted in FIG. 1 for explaining the symmetry of cobalt atoms and the symmetry of oxygen atoms, lithium practically exists between CoO₂ layers at approximately 12 atomic % with respect to cobalt. Furthermore, a slight amount of magnesium preferably exists between the CoO₂ layers, i.e., in lithium sites. In addition, it is preferable that halogen such as fluorine randomly exist in oxygen sites at a slight concentration.

Magnesium randomly existing between the CoO₂ layers, i.e., in the lithium sites, at a slight concentration has an effect of inhibiting a deviation of the CoO₂ layers. Thus, in the positive electrode active material 100, a change in the crystal structure when high-voltage charging is performed and a large amount of lithium is extracted is inhibited as compared with conventional LiCoO₂. As indicated by dotted lines in FIG. 1, for example, there is a very little deviation of the CoO₂ layers between the crystal structures.

In addition, in the positive electrode active material 100, a difference in the volume per unit cell between the O3-type crystal structure with a depth of charge of 0 and the pseudo-spinel crystal structure with a depth of charge of 0.88 is less than or equal to 2.5%, more specifically, less than or equal to 2.2%.

Thus, the crystal structure is unlikely to be broken by repeated high-voltage charging and discharging.

Magnesium randomly existing between the CoO₂ layers, i.e., in the lithium sites, at a slight concentration has an effect of inhibiting a deviation of the CoO₂ layers. Therefore, magnesium is preferably distributed over a particle of the positive electrode active material 100. In addition, to distribute magnesium over the particle, heat treatment is preferably performed in a formation process of the positive electrode active material 100.

However, cation mixing occurs when the heat treatment temperature is excessively high, so that magnesium is highly likely to enter the cobalt sites. Magnesium in the cobalt sites loses the effect of maintaining the R-3m structure. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over the particle. The addition of the halogen compound decreases the melting point of lithium cobalt oxide. The decrease in the melting point makes it easier to distribute magnesium over the particle at a temperature at which the cation mixing is unlikely to occur. Furthermore, the fluorine compound probably increases corrosion resistance to hydrofluoric acid generated by decomposition of an electrolyte solution.

As described above, the positive electrode active material of one embodiment of the present invention contains the element X, whereby a deviation of the layers containing the element M can be inhibited in the charged state.

### <Element X>

The element X in a particle included in the positive electrode active material is described below.

### «Surface Portion»

The positive electrode active material 100 includes a particle. The particle included in the positive electrode active material includes a region having a crystal structure, for example. The region having the crystal structure is preferably a material functioning as a positive electrode in a secondary battery.

The crystal structure is a rock-salt layered structure, for example. The crystal structure can be represented by the space group R-3m, for example.

The element X is preferably distributed over the particle included in the positive electrode active material 100, and further preferably, the concentration of the element X in the surface portion of the particle is higher than the average in the particle. In other words, the concentration of the element X in the surface portion of the particle that is measured by XPS or the like is preferably higher than the average concentration of the element X in the particle measured by ICP-MS or the like. The entire surface of the particle is a kind of crystal defects and the element A serving as a carrier ion is extracted from the surface during charging; thus, the concentration of the element A in the surface of the particle tends to be lower than that in the inner portion of the particle. Therefore, the surface of the particle tends to be unstable and its crystal structure is likely to be broken. The higher the concentration of the element X in the surface portion is, the more effectively the change in the crystal structure can be inhibited. In addition, a high concentration of the element X in the surface portion probably increases corrosion resistance to hydrofluoric acid generated by decomposition of an electrolyte solution.

In addition, the concentration of halogen such as fluorine in the surface portion of the positive electrode active material 100 is preferably higher than the average concentration of halogen such as fluorine in the particle. When halogen exists in the surface portion that is a region in contact with the electrolyte solution, the corrosion resistance to hydrofluoric acid can be effectively increased.

In this manner, the surface portion of the positive electrode active material 100 preferably has higher concentrations of the element X and fluorine than the inner portion and a composition different from that in the inner portion. In addition, the composition preferably has a crystal structure stable at normal temperature. Thus, the surface portion may have a crystal structure different from that of the inner portion. For example, at least part of the surface portion of the positive electrode active material 100 may have a rock-salt crystal structure. Furthermore, in the case where the surface portion and the inner portion have different crystal structures, the orientations of crystals in the surface portion and the inner portion are preferably substantially aligned.

Note that in the surface portion where only a compound containing the element X is contained or a compound containing the element X and a compound containing the element M form a solid solution, for example, MgO and CoO(II) form a solid solution, it is difficult to insert and extract the element A. Thus, the surface portion should contain at least the element M, and further contain the element A in the discharged state to have a path through which the element A is inserted and extracted. In addition, the concentration of the element M is preferably higher than the concentration of the element X.

### «Grain Boundary»

The element X or halogen contained in the positive electrode active material 100 may randomly exist in the inner portion at a slight concentration, but part of the element is further preferably segregated at a grain boundary.

In other words, the concentration of the element X in the crystal grain boundary and its vicinity of the positive electrode active material 100 is preferably higher than that in the other regions in the inner portion. In addition, the halogen concentration in the crystal grain boundary and its vicinity is also preferably higher than that in the other regions in the inner portion.

Like the particle surface, the crystal grain boundary is also a plane defect. Thus, the crystal grain boundary tends to be unstable and its crystal structure easily starts to change. Therefore, the higher the concentration of the element X in the crystal grain boundary and its vicinity is, the more effectively the change in the crystal structure can be inhibited.

Furthermore, even when cracks are generated along the crystal grain boundary of the particle of the positive electrode active material 100, high concentrations of the element X and halogen in the crystal grain boundary and its vicinity increase the concentrations of the element X and halogen in the vicinity of a surface generated by the cracks. Thus, the positive electrode active material after the cracks are generated can also have increased corrosion resistance to hydrofluoric acid.

Note that in this specification and the like, the vicinity of the crystal grain boundary refers to a region of approximately 10 nm from the grain boundary.

### «Particle Diameter»

A too large particle diameter of the positive electrode active material 100 causes problems such as difficulty in diffusion of the element A and too much surface roughness of an active material layer in coating a current collector. By contrast, a too small particle diameter also causes problems such as difficulty in supporting the active material layer in coating the current collector and overreaction with an electrolyte solution. Therefore, D50 is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### «Charging Method»

High-voltage charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode current collector made of aluminum foil that is coated with slurry in which a positive electrode active material, a conductive additive, and a binder are mixed can be used as a positive electrode.

In the case where lithium is used as the element A, a lithium metal can be used for the counter electrode. Note that when a material other than the lithium metal is used for the counter electrode, the potential of a secondary battery differs from the potential of the positive electrode. Unless otherwise specified, voltages and potentials in this specification and the like refer to the potentials of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

A positive electrode can and a negative electrode can that are formed using stainless steel (SUS) can be used.

The coin cell manufactured under the above conditions is charged with constant current at 4.6 V and 0.5 C and then charged with constant voltage until the current value reaches 0.01 C. Note that here, 1 C is set to 137 mA/g. The temperature is set to 25° C. After the charging is performed in this manner, the coin cell is disassembled in a glove box with an argon atmosphere and the positive electrode is taken out, whereby the high-voltage charged positive electrode active material can be obtained. In order to inhibit reaction with components in the external world, the positive electrode active material is preferably hermetically sealed in an argon atmosphere in performing various analyses later. For example, XRD can be performed on the positive electrode active material enclosed in an airtight container with an argon atmosphere.

### «XPS»

A region from the surface to a depth of approximately 2 to 8 nm (normally, approximately 5 nm) can be analyzed by X-ray photoelectron spectroscopy (XPS); thus, the concentration of each element in approximately half of the surface portion can be quantitatively analyzed. In addition, the bonding states of the elements can be analyzed by narrow scanning analysis. Note that the quantitative accuracy of XPS is approximately ±1 atomic % in many cases. The lower detection limit depends on the element but is approximately 1 atomic %.

When the positive electrode active material 100 is analyzed by XPS and the concentration of the element M is set to 1, the relative value of the concentration of the element X is preferably greater than or equal to 0.4 and less than or equal to 1.5, further preferably greater than or equal to 0.45 and less than 1.00. Furthermore, the relative value of the concentration of halogen such as fluorine is preferably greater than or equal to 0.05 and less than or equal to 1.5, further preferably greater than or equal to 0.3 and less than or equal to 1.00.

In addition, when the positive electrode active material 100 is analyzed by XPS, a peak indicating the bonding energy of fluorine with another element is preferably higher than or equal to 682 eV and lower than 685 eV, further preferably approximately 684.3 eV. This value is different from both of the bonding energy of lithium fluoride, which is 685 eV, and the bonding energy of magnesium fluoride, which is 686 eV. That is, when the positive electrode active material 100 contains fluorine, bonding other than bonding of lithium fluoride and magnesium fluoride is preferable.

Furthermore, in the case where the element X is magnesium, when the positive electrode active material 100 is analyzed by XPS, a peak indicating the bonding energy of magnesium with another element is preferably higher than or equal to 1302 eV and lower than 1304 eV, further preferably approximately 1303 eV. This value is different from the bonding energy of magnesium fluoride, which is 1305 eV, and is close to the bonding energy of magnesium oxide. That is, when the positive electrode active material 100 contains magnesium, it is preferable that the bonding be other than that of magnesium fluorine.

### «EDX»

In the EDX measurement, to measure a region while scanning the region and evaluate two-dimensionally is referred to as EDX surface analysis in some cases. In addition, to extract data of a linear region from EDX surface analysis and evaluate the atomic concentration distribution in a positive electrode active material particle is referred to as line analysis in some cases.

The concentration of the element X and the concentration of fluorine in the inner portion, the surface portion, and the vicinity of the crystal grain boundary can be quantitatively analyzed by the EDX surface analysis (e.g., element mapping). In addition, peaks of the concentration of the element X and the concentration of fluorine can be analyzed by the EDX line analysis.

When the positive electrode active material 100 is analyzed by the EDX line analysis, a peak of the concentration of the element X in the surface portion preferably exists in a region from the surface of the positive electrode active material 100 to a depth of 3 nm toward the center, further preferably to a depth of 1 nm, still further preferably to a depth of 0.5 nm.

It is preferable that the distribution of fluorine contained in the positive electrode active material 100 overlap with the distribution of the element X. Thus, when the EDX line analysis is performed, a peak of the fluorine concentration in the surface portion preferably exists in a region from the surface of the positive electrode active material 100 to a depth of 3 nm toward the center, further preferably to a depth of 1 nm, still further preferably to a depth of 0.5 nm.

When the line analysis or the surface analysis is performed on the positive electrode active material 100, the atomic ratio of the element X to cobalt (X/Co) in the vicinity of the crystal grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

«dQ/dVvsV Curve»

Moreover, when the positive electrode active material of one embodiment of the present invention is discharged at a low rate of, for example, 0.2 C or less after high-voltage charging, a characteristic change in voltage appears just before the end of discharging, in some cases. This change can be clearly observed by the fact that at least one peak appears within the range of 3.5 V to 3.9 V in dQ/dVvsV curve calculated from a discharge curve.

This embodiment can be implemented in appropriate combination with any of the other embodiments.

### Embodiment 2

In this embodiment, an example of a crystal structure of a positive electrode active material of one embodiment of the present invention is described.

The positive electrode active material described in Embodiment 1 has a pseudo-spinel structure described below in some cases. The case where AM_{y}O_{z} (y>0, z>0) contains the element X shown in Table 4 to Table 6 or the like, y=1, z=2, the element M is cobalt, and the element X is magnesium is described below as an example of the pseudo-spinel structure.

### «Pseudo-Spinel»

The crystal structure with a depth of charge of 0 (in the discharged state) in FIG. 1 belongs to R-3m(O3) as in FIG. 2. By contrast, the positive electrode active material 100 of one embodiment of the present invention has a crystal with a structure different from that in FIG. 2 when it is sufficiently charged and has a depth of charge of approximately 0.88. The crystal structure of the space group R-3m is referred to as a pseudo-spinel crystal structure in this specification and the like. Note that although the indication of lithium is omitted in the diagram of the pseudo-spinel crystal structure shown in FIG. 1 for explaining the symmetry of cobalt atoms and the symmetry of oxygen atoms, lithium practically exists between CoO₂ layers at approximately 12 atomic % with respect to cobalt. In addition, in both the O3-type crystal structure and the pseudo-spinel crystal structure, magnesium preferably exists between the CoO₂ layers, i.e., in lithium sites, at a slight concentration. In addition, it is preferable that halogen such as fluorine randomly exist in oxygen sites at a slight concentration.

In the positive electrode active material 100, a change in the crystal structure when high-voltage charging is performed and a large amount of lithium is extracted is inhibited as compared with conventional LiCoO₂. As indicated by dotted lines in FIG. 1, for example, there is little deviation in the CoO₂ layers in the crystal structures.

In addition, in the positive electrode active material 100, a difference in the volume per unit cell between the O3-type crystal structure with a depth of charge of 0 and the pseudo-spinel crystal structure with a depth of charge of 0.88 is less than or equal to 2.5%, more specifically, less than or equal to 2.2%.

Thus, the crystal structure is unlikely to be broken by repeated high-voltage charging and discharging.

Note that in the unit cell of the pseudo-spinel crystal structure, coordinates of cobalt and oxygen can be represented by Co (0, 0, 0.5) and 0 (0, 0, x) within the range of 0.20≤x≤0.25.

### «XRD»

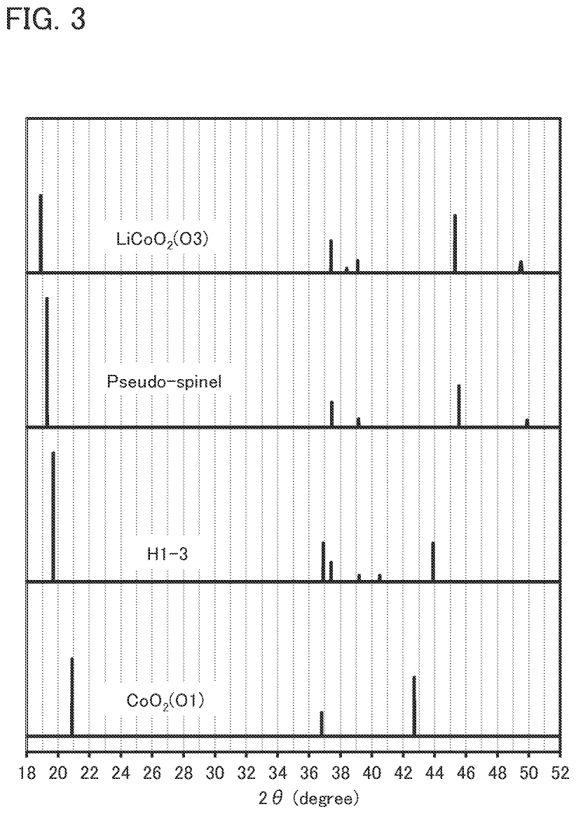

FIG. 3 shows ideal powder XRD patterns with the CuKα1 ray that are calculated from models of the pseudo-spinel crystal structure and the H1-3 type crystal structure. In addition, for comparison, FIG. 3 also shows ideal XRD patterns calculated from the crystal structures of LiCoO₂(O3) with a depth of charge of 0 and CoO₂(O1) with a depth of charge of 1. Note that the patterns of LiCoO₂(O3) and CoO₂(O1) are made from crystal structure data obtained from ICSD (Inorganic Crystal Structure Database) (See Non-Patent Document 5) using Reflex Powder Diffraction, which is a module of Materials Studio (BIOVIA). The range of 2θ is from 15° to 75°, Step size is 0.01, the wavelength λ1 is 1.540562×10⁻¹⁰ m, λ2 is not set, and Monochromator is a single monochromator. The pattern of the H1-3 type crystal structure is made from the crystal structure data disclosed in Non-Patent Document 3 in a similar manner. The pattern of the pseudo-spinel crystal structure is estimated from the XRD pattern of the positive electrode active material of one embodiment of the present invention, the crystal structure is fitted with TOPAS ver. 3 (crystal structure analysis software manufactured by Bruker Corporation), and XRD patterns are made in a manner similar to those of other structures.

As shown in FIG. 3, the pseudo-spinel crystal structure has diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 219 of 19.30±0.10° (greater than or equal to 19.20° and less than or equal to 19.40°) and 2θ of 45.55±0.05° (greater than or equal to 45.50° and less than or equal to 45.60°). However, in the H1-3 type crystal structure and CoO₂(P-3m1, O1), peaks at these positions do not appear. Thus, the peaks at 2θ of 19.30±0.20° and 2θ of 45.55±0.10° in the high-voltage charged state can be the features of the positive electrode active material 100 of one embodiment of the present invention.

It can also be said that the positions where the XRD diffraction peaks appear are close in the crystal structure with a depth of charge of 0 and the crystal structure in the high-voltage charged state. More specifically, a difference in the positions of two or more, further preferably three or more of the main diffraction peaks between both of the crystal structures is 2θ of less than or equal to 0.7, further preferably 2θ of less than or equal to 0.5.

Although the positive electrode active material 100 of one embodiment of the present invention has the pseudo-spinel crystal structure when charged with high voltage, not all particles necessarily have the pseudo-spinel crystal structure. The particles may have another crystal structure, or some of the particles may be amorphous. Note that when the XRD patterns are analyzed by the Rietveld analysis, the pseudo-spinel crystal structure preferably accounts for more than or equal to 50 wt %, further preferably more than or equal to 60 wt %, still further preferably more than or equal to 66 wt %. The positive electrode active material in which the pseudo-spinel crystal structure accounts for more than or equal to 50 wt %, further preferably more than or equal to 60 wt %, still further preferably more than or equal to 66 wt % can have sufficiently good cycle performance.

Furthermore, even after 100 or more cycles of charging and discharging, the pseudo-spinel crystal structure preferably accounts for more than or equal to 35 wt %, further preferably more than or equal to 40 wt %, still further preferably more than or equal to 43 wt % when the Rietveld analysis is performed.

In addition, the crystallite size of the pseudo-spinel structure included in the positive electrode active material particle does not decrease to less than approximately one-tenth that of LiCoO₂(O3) in the discharged state. Thus, a clear peak of the pseudo-spinel crystal structure can be observed after the high-voltage charging even under the same XRD measurement conditions as those of a positive electrode before the charging and discharging. By contrast, simple LiCoO₂ has a small crystallite size and a broad small peak even when it can have a structure part of which is similar to the pseudo-spinel crystal structure. The crystallite size can be calculated from the half width of the XRD peak.

In addition, the layered rock-salt crystal structure included in the positive electrode active material particle in the discharged state, which can be estimated from the XRD patterns, preferably has a small lattice constant of the c-axis. The lattice constant of the c-axis increases when a foreign element is substituted at the lithium position or cobalt enters an oxygen-tetracoordinated position (A site), for example. For this reason, the positive electrode active material with excellent cycle performance probably can be manufactured by forming a composite oxide having a layered rock-salt crystal structure with few defects such as foreign element substitutions and Co₃O₄ having the spinel crystal structure and then mixing a magnesium source and a fluorine source with the composite oxide and inserting magnesium into the lithium position.

The lattice constant of the c-axis in the crystal structure of the positive electrode active material in the discharged state before annealing is preferably less than or equal to 14.060×10⁻¹⁰ m, further preferably less than or equal to 14.055×10⁻¹⁰ m, still further preferably less than or equal to 14.051×10⁻¹⁰ m. The lattice constant of the c-axis after annealing is preferably less than or equal to 14.060×10⁻¹⁰ m.

In order to set the lattice constant of the c-axis within the above range, the amount of impurities is preferably as small as possible. In particular, the amount of addition of transition metals other than cobalt, manganese, and nickel is preferably as small as possible; specifically, preferably less than or equal to 3000 ppm wt, further preferably less than or equal to 1500 ppm wt. In addition, cation mixing between lithium and cobalt, manganese, and nickel is preferably less likely to occur.

Note that features that are apparent from the XRD pattern are features of the inner structure of the positive electrode active material. In a positive electrode active material with an average particle diameter (D50) of approximately 1 μm to 100 μm, the volume of a surface portion is negligible compared with that of an inner portion; therefore, even when the surface portion of the positive electrode active material 100 has a crystal structure different from that of the inner portion, the crystal structure of the surface portion is highly unlikely to appear in the XRD pattern.

### «ESR»

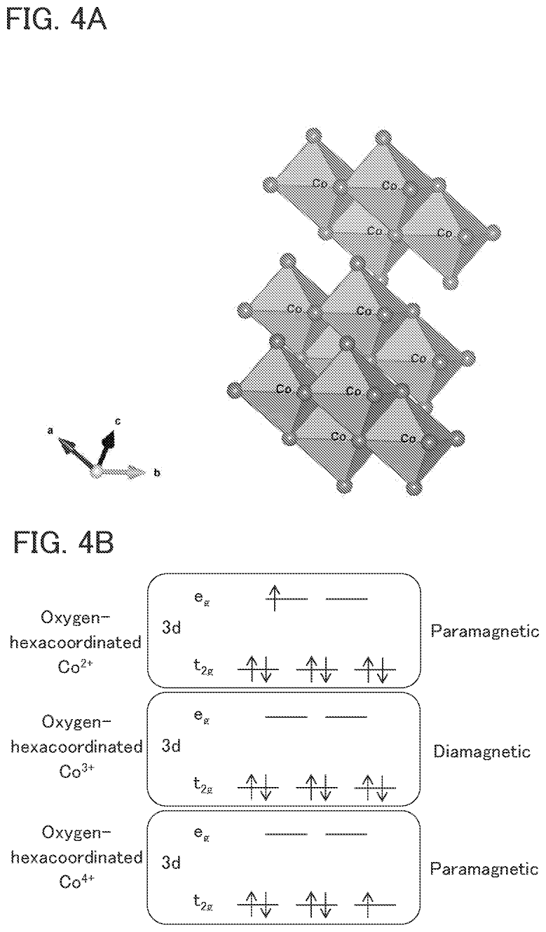

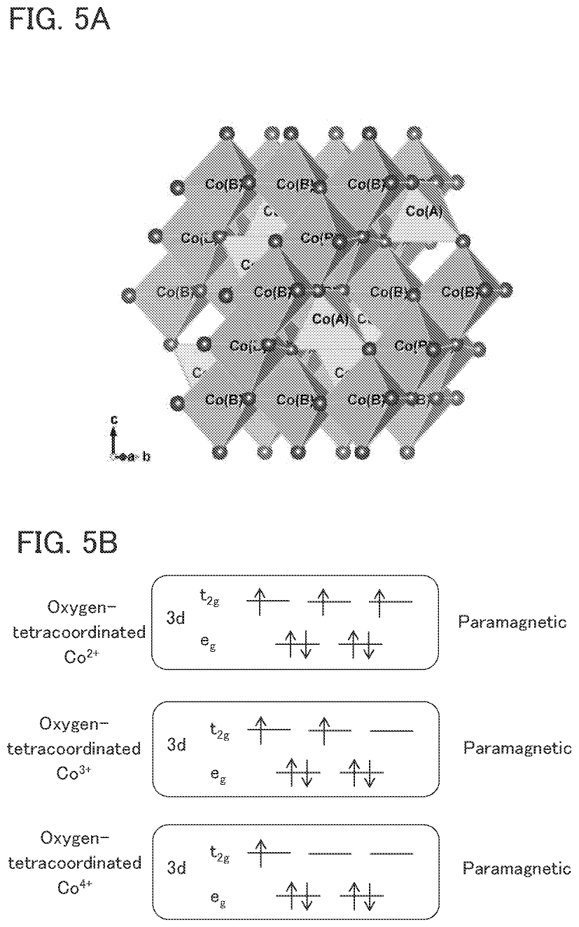

Here, the case in which the difference between the pseudo-spinel crystal structure and another crystal structure is determined using ESR is described using FIG. 4 and FIG. 5. In the pseudo-spinel crystal structure, cobalt exists in the oxygen-hexacoordinated site, as illustrated in FIG. 1 and FIG. 4A. In oxygen-hexacoordinated cobalt, a 3d orbital is divided into an e_{g} orbital and a t_{2g} orbital as shown in FIG. 4B, and the energy of the t_{2g} orbital located aside from the direction in which oxygen exists is low. Part of cobalt that exists in the oxygen-hexacoordinated site is cobalt of diamagnetic Co³⁺ in which the entire t_{2g} orbital is filled. However, another part of cobalt that exists in the oxygen-hexacoordinated site may be cobalt of paramagnetic Co²⁺ or Co⁴⁺. Although both Co²⁺ and Co⁴⁺ have one unpaired electron and thus cannot be distinguished by ESR, paramagnetic cobalt may have either valence depending on the valences of surrounding elements.

By contrast, it is reported that a conventional positive electrode active material can have the spinel crystal structure not containing lithium in its surface portion in the charged state. In that case, the positive electrode active material contains Co₃O₄ having the spinel crystal structure illustrated in FIG. 5A.

When the spinel is represented by a general formula A[B₂]O₄, the element A is oxygen-tetracoordinated and the element B is oxygen-hexacoordinated. Thus, in this specification and the like, the oxygen-tetracoordinated site is referred to as an A site, and the oxygen-hexacoordinated site is referred to as a B site in some cases.

In Co₃O₄ having the spinel crystal structure, cobalt exists not only in the oxygen-hexacoordinated B site but also in the oxygen-tetracoordinated A site. In oxygen-tetracoordinated cobalt, between the divided e_{g} orbital and t_{2g} orbital, the e_{g} orbital has lower energy as shown in FIG. 5B. Thus, each of oxygen-tetracoordinated Co²⁺, Co³⁺, and Co⁴⁺ includes an unpaired electron and therefore is paramagnetic. Accordingly, when the particles that sufficiently contain Co₃O₄ having the spinel crystal structure are analyzed by ESR or the like, peaks attributed to paramagnetic cobalt, oxygen-tetracoordinated Co²⁺, Co³⁺, or Co⁴⁺, should be detected.

However, in the positive electrode active material 100 of one embodiment of the present invention, peaks attributed to oxygen-tetracoordinated paramagnetic cobalt are too few to be observed. Thus, unlike the spinel crystal structure, the pseudo-spinel crystal structure in this specification and the like does not contain an enough amount of oxygen-tetracoordinated cobalt to be detected by ESR. Therefore, the peaks that are attributed to spinel-type Co₃O₄ and can be detected by ESR or the like of the positive electrode active material of one embodiment of the present invention are small or too few to be observed as compared to the conventional example, in some cases. Spinel-type Co₃O₄ does not contribute to the charge and discharge reaction; thus, the amount of spinel-type Co₃O₄ is preferably as small as possible. It can be determined also from the ESR analysis that the positive electrode active material 100 is different from the conventional example.

This embodiment can be implemented in appropriate combination with any of the other embodiments.

### Embodiment 3

In this embodiment, an example of a method for forming a positive electrode active material of one embodiment of the present invention is described.

### [Formation Method of Positive Electrode Active Material]

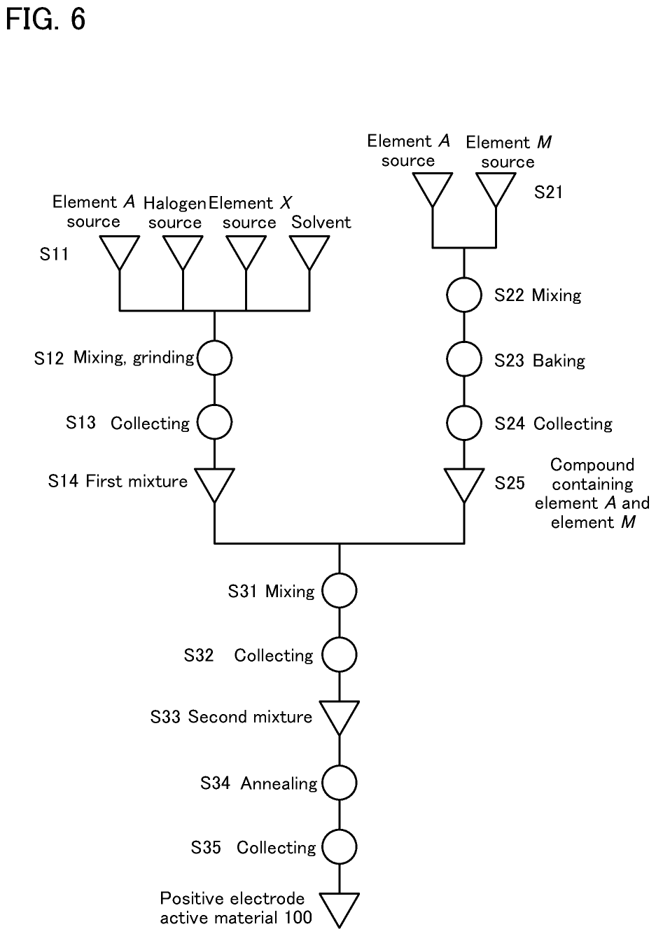

First, an example of a formation method of the positive electrode active material 100, which is one embodiment of the present invention, is described using FIG. 6.

### <Step S11>

As shown in Step S11 in FIG. 6, a halogen source such as a fluorine source or a chlorine source and an element X source are prepared as materials of a first mixture. In addition, an element A source is preferably prepared as well.

In addition, in the case where the following mixing and grinding step is performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used.

### <Step S12>

Next, as shown in Step S12, the materials of the first mixture are mixed and ground. Although the mixing can be performed by a dry process or a wet process, the wet process is preferable because the materials can be ground to a smaller size. For example, a ball mill, a bead mill, or the like can be used for the mixing. When the ball mill is used, a zirconia ball is preferably used as media, for example. The mixing and grinding step is preferably performed sufficiently to pulverize the first mixture.

### <Step S13, Step S14>

The materials mixed and ground in the above are collected (Step S13), whereby the first mixture is obtained (Step S14).

The first mixture preferably has an average particle diameter (D50: also referred to as a median diameter) of greater than or equal to 600 nm and less than or equal to 20 μm, further preferably greater than or equal to 1 μm and less than or equal to 10 82 m, for example. When mixed with a compound containing the element A and the element M in a later step, the first mixture pulverized to such a small size is easily attached to the surface of the compound particle uniformly. The first mixture is preferably attached to the surface of the compound particle uniformly because both halogen and the element X are easily distributed also to the surface portion of the compound particle after heating.

### <Step S21>

Next, as shown in Step S21 in FIG. 6, the element A source and an element M source are prepared as materials of the compound containing the element A and the element M.

As the element M source, an oxide of the element M, a hydroxide of the element M, or the like can be used.

### <Step S22>

Next, the element A source and the element M source are mixed (Step S22). The mixing can be performed by a dry process or a wet process. For example, a ball mill, a bead mill, or the like can be used for the mixing. When the ball mill is used, a zirconia ball is preferably used as media, for example.

### <Step S23>

Next, the materials mixed in the above are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Excessively low temperature might result in insufficient decomposition and melting of the starting materials. By contrast, excessively high temperature might cause a defect due to excessive reduction of the element M such as a transition metal, evaporation of the element A, or the like.

The heating time is preferably longer than or equal to two hours and shorter than or equal to 20 hours. The baking is preferably performed in an atmosphere with little water, such as dry air (e.g., a dew point is lower than or equal to −50° C., preferably lower than or equal to 100° C.). For example, it is preferable that the heating be performed at 1000° C. for 10 hours, the temperature rise be 200° C./h, and the flow rate of a dry atmosphere be 10 L/min. After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S23 is not essential. As long as later Step S24, Step S25, and Step S31 to Step S34 are performed without problems, it is possible to perform cooling to a temperature higher than room temperature.

### <Step S24, Step S25>

The materials baked in the above are collected (Step S24), whereby the compound containing the element A and the element M is obtained (Step S25). Specifically, an oxide represented by the chemical formula AM_{y}O_{z} (y>0, z>0) is obtained, for example.

Alternatively, a compound containing the element A and the element M that is synthesized in advance may be used as Step S25. In this case, Step S21 to Step S24 can be skipped.

### <Step S31>

Next, the first mixture and the compound containing the element A and the element M are mixed (Step S31). The ratio of the number TM of the element M atoms in the compound containing the element A and the element M to the number X_{Mix1} of the element X atoms contained in the first mixture Mix1 is TM:X_{Mix1}=1:y (0.0005≤y≤0.03), TM:X_{Mix1}=1:y (0.001≤y≤0.01), or approximately TM:X_{Mix1}=1:0.005, for example.

### <Step S32, Step S33>

The materials mixed in the above are collected (Step S32), whereby a second mixture is obtained (Step S33).

### <Step S34>

Next, the second mixture is heated. This step is sometimes referred to as annealing or second heating to distinguish this step from the heating step performed before.

It is considered that when the second mixture is annealed, a material having a low melting point (e.g., a compound used as the halogen source) in the first mixture is melted first and distributed to the surface portion of the composite compound particle. Then, the existence of the melted material decreases the melting points of other materials, presumably resulting in melting of the other materials.

Then, the elements that are contained in the first mixture and are distributed to the surface portion probably form a solid solution in the compound containing lithium, the element A, and the element X.

The elements contained in the first mixture diffuse faster in the surface portion of the particle of the compound containing the element A and the element X and the vicinity of the grain boundary than in the inner portion. Therefore, the concentrations of the element X and halogen in the surface portion and the vicinity of the grain boundary are higher than those of the element X and halogen in the inner portion.

### <Step S35>

The materials annealed in the above are collected, so that the positive electrode active material 100 of one embodiment of the present invention is obtained.

In addition, the positive electrode active material 100 formed through the above steps may be further covered with another material. In addition, heating may be further performed.

For example, the positive electrode active material 100 and a compound containing phosphoric acid can be mixed. In addition, heating can be performed after mixing. When the compound containing phosphoric acid is mixed, it is possible to obtain the positive electrode active material 100 where elution of a transition metal such as cobalt is inhibited even when the high-voltage charged state is held for a long time. Moreover, heating after mixing enables more uniform coverage with phosphoric acid.

As the compound containing phosphoric acid, for example, lithium phosphate, ammonium dihydrogen phosphate, or the like can be used. The mixing can be performed by a solid phase method, for example. The heating can be performed at higher than or equal to 800° C. for two hours, for example.

### [Specific Example of Formation Method of Positive Electrode Active Material]

A specific example of the formation method is described below. Magnesium, lithium, and a transition metal are used as the element X, the element A, and the element M, respectively.

### <Step S11>

In Step S11, a fluorine source, a lithium source, and a magnesium source are prepared.

As the fluorine source, for example, lithium fluoride, magnesium fluoride, or the like can be used. Among them, lithium fluoride, which has a relatively low melting point of 848° C., is preferable because it is easily melted in an annealing step described later. As the chlorine source, for example, lithium chloride, magnesium chloride, or the like can be used. As the magnesium source, for example, magnesium fluoride, magnesium oxide, magnesium hydroxide, magnesium carbonate, or the like can be used. As the lithium source, for example, lithium fluoride or lithium carbonate can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source and the lithium source, and magnesium fluoride MgF₂ is prepared as the fluorine source and the magnesium source. When lithium fluoride LiF and magnesium fluoride MgF₂ are mixed at approximately LiF:MgF₂=65:35 (molar ratio), the effect of reducing the melting point becomes the highest (Non-Patent Document 4). On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

### <Step S12>

Next, in Step S12, the materials of the first mixture are mixed and ground.

### <Step S13, Step S14>

The materials mixed and ground in the above are collected (Step S13), whereby the first mixture is obtained (Step S14).

The first mixture preferably has an average particle diameter (D50: also referred to as a median diameter) of greater than or equal to 600 nm and less than or equal to 20 μm, further preferably greater than or equal to 1 μm and less than or equal to 10 μm, for example. When mixed with a composite oxide containing lithium, a transition metal, and oxygen in a later step, the first mixture pulverized to such a small size is easily attached to the surface of the composite oxide particle uniformly. The first mixture is preferably attached to the surface of the composite oxide particle uniformly because both halogen and magnesium are easily distributed to the surface portion of the composite oxide particle after heating. When there is a region containing neither halogen nor magnesium in the surface portion, a pseudo-spinel crystal structure, which is described later, might be less likely to be obtained in the charged state.

### <Step S21>

Next, in Step S21, a lithium source and a transition metal source are prepared as materials of the composite oxide containing lithium, the transition metal, and oxygen.

As the lithium source, for example, lithium carbonate, lithium fluoride, or the like can be used.

As the transition metal, at least one of cobalt, manganese, and nickel can be used. The composite oxide containing lithium, the transition metal, and oxygen preferably has a layered rock-salt crystal structure, and thus cobalt, manganese, and nickel preferably have a mixing ratio at which the composite oxide can have the layered rock-salt crystal structure. In addition, aluminum may be added to the transition metal as long as the composite oxide can have the layered rock-salt crystal structure.

As the transition metal source, an oxide or a hydroxide of the transition metal, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S22>

Next, in Step S22, the lithium source and the transition metal source are mixed.

### <Step S23>

Next, the materials mixed in the above are heated.

### <Step S24, Step S25>

The materials baked in the above are collected (Step S24), whereby the composite oxide containing lithium, the transition metal, and oxygen is obtained (Step S25). Specifically, lithium cobalt oxide, lithium manganese oxide, lithium nickel oxide, lithium cobalt oxide in which manganese is substituted for part of cobalt, or lithium nickel-manganese-cobalt oxide is obtained.

Alternatively, a composite oxide containing lithium, a transition metal, and oxygen that is synthesized in advance may be used as Step S25.

In the case where the composite oxide containing lithium, the transition metal, and oxygen that is synthesized in advance is used, a composite oxide with few impurities is preferably used. In this specification and the like, lithium, cobalt, nickel, manganese, aluminum, and oxygen are main components of the composite oxide containing lithium, the transition metal, and oxygen and the positive electrode active material, and elements other than the main components are regarded as impurities. For example, when analyzed by a glow discharge mass spectroscopy method, the total impurity element concentration is preferably less than or equal to 10,000 ppm wt, further preferably less than or equal to 5000 ppm wt. In particular, the total impurity concentration of transition metals such as titanium and arsenic is preferably less than or equal to 3000 ppm wt, further preferably less than or equal to 1500 ppm wt.

For example, as lithium cobalt oxide synthesized in advance, a lithium cobalt oxide particle (product name: CELLSEED C-10N) manufactured by NIPPON CHEMICAL INDUSTRIAL CO., LTD. can be used. This lithium cobalt oxide has an average particle diameter (D50) of approximately 12 μm, and, in impurity analysis by a glow discharge mass spectroscopy method (GD-MS), a magnesium concentration and a fluorine concentration of less than or equal to 50 ppm wt, a calcium concentration, an aluminum concentration, and a silicon concentration of less than or equal to 100 ppm wt, a nickel concentration of less than or equal to 150 ppm wt, a sulfur concentration of less than or equal to 500 ppm wt, an arsenic concentration of less than or equal to 1100 ppm wt, and concentrations of elements other than lithium, cobalt, and oxygen of less than or equal to 150 ppm wt.

Alternatively, a lithium cobalt oxide particle (product name: CELLSEED C-5H) manufactured by NIPPON CHEMICAL INDUSTRIAL CO., LTD. can be used. This lithium cobalt oxide has an average particle diameter (D50) of approximately 6.5 μm, and concentrations of elements other than lithium, cobalt, and oxygen that are approximately equal to or less than those of C-10N in impurity analysis by GD-MS.

The composite oxide containing lithium, the transition metal, and oxygen in Step S25 preferably has the layered rock-salt crystal structure with few defects and distortions. Therefore, the composite oxide preferably includes few impurities. In the case where the composite oxide containing lithium, the transition metal, and oxygen includes a lot of impurities, the crystal structure is highly likely to have a lot of defects or distortions.

### <Step S31>

Next, the first mixture and the composite oxide containing lithium, the transition metal, and oxygen are mixed (Step S31).

The condition of the mixing in Step S31 is preferably milder than that of the mixing in Step S12 not to damage the particles of the composite oxide. For example, a condition with a lower rotation frequency or shorter time than the mixing in Step S12 is preferable. In addition, it can be said that the dry process has a milder condition than the wet process. For example, a ball mill, a bead mill, or the like can be used for the mixing. When the ball mill is used, a zirconia ball is preferably used as media, for example.

### <Step S32, Step S33>

The materials mixed in the above are collected (Step S32), whereby the second mixture is obtained (Step S33).

Note that this embodiment describes a method for adding the mixture of lithium fluoride and magnesium fluoride to lithium cobalt oxide with few impurities; however, one embodiment of the present invention is not limited thereto. A mixture obtained through baking after addition of a magnesium source and a fluorine source to the starting materials of lithium cobalt oxide may be used instead of the second mixture in Step S33. In that case, there is no need to separate Step S11 to Step S14 and Step S21 to Step S25, which is simple and productive.

Alternatively, lithium cobalt oxide to which magnesium and fluorine are added in advance may be used. When lithium cobalt oxide to which magnesium and fluorine are added is used, the process can be simpler because the steps up to Step S32 can be omitted.

In addition, a magnesium source and a fluorine source may be further added to lithium cobalt oxide to which magnesium and fluorine are added in advance.

### <Step S34>

Next, the second mixture is heated. This step is sometimes referred to as annealing or second heating to distinguish this step from the heating step performed before.

The annealing is preferably performed at an appropriate temperature for an appropriate time. The appropriate temperature and time depend on the conditions such as the particle size and the composition of the composite oxide containing lithium, the transition metal, and oxygen in Step S25. In the case where the particle size is small, the annealing is preferably performed at a lower temperature or for a shorter time than the case where the particle size is large, in some cases.

When the average particle diameter (D50) of the particles in Step S25 is approximately 12 μm, the annealing temperature is preferably higher than or equal to 600° C. and lower than or equal to 950° C., for example. The annealing time is preferably longer than or equal to three hours, further preferably longer than or equal to 10 hours, still further preferably longer than or equal to 60 hours, for example.

On the other hand, when the average particle diameter (D50) of the particles in Step S25 is approximately 5 μm, the annealing temperature is preferably higher than or equal to 600° C. and lower than or equal to 950° C., for example. The annealing time is preferably longer than or equal to one hour and shorter than or equal to 10 hours, further preferably approximately two hours, for example.

The temperature decreasing time after the annealing is, for example, preferably longer than or equal to 10 hours and shorter than or equal to 50 hours.

It is considered that when the second mixture is annealed, a material having a low melting point (e.g., lithium fluoride, which has a melting point of 848° C.) in the first mixture is melted first and distributed to the surface portion of the composite oxide particle. Next, the existence of the melted material decreases the melting points of other materials, presumably resulting in melting of the other materials. For example, magnesium fluoride (having a melting point of 1263° C.) is presumably melted and distributed to the surface portion of the composite oxide particle.

Then, the elements that are contained in the first mixture and are distributed to the surface portion probably form a solid solution in the composite oxide containing lithium, the transition metal, and oxygen.

The elements contained in the first mixture diffuse faster in the surface portion of the composite oxide particle and the vicinity of the grain boundary than in the inner portion. Therefore, the concentrations of magnesium and halogen in the surface portion and the vicinity of the grain boundary are higher than those of magnesium and halogen in the inner portion. As described later, the higher the magnesium concentration in the surface portion and the vicinity of the grain boundary is, the more effectively the change in the crystal structure can be inhibited.

### <Step S35>

The materials annealed in the above are collected, so that the positive electrode active material 100 of one embodiment of the present invention is obtained.

When formed by a method like above, the positive electrode active material having the pseudo-spinel crystal structure with few defects in high-voltage charging can be formed. A positive electrode active material in which the pseudo-spinel crystal structure accounts for more than or equal to 50% when analyzed by Rietveld analysis has excellent cycle performance and rate characteristics.

To include magnesium and fluorine in the positive electrode active material and to anneal the positive electrode active material at an appropriate temperature for an appropriate time are effective in forming the positive electrode active material having the pseudo-spinel crystal structure after high-voltage charging. The magnesium source and the fluorine source may be added to the starting materials of the composite oxide. However, when the melting points of the magnesium source and the fluorine source are higher than the baking temperature, the magnesium source and the fluorine source added to the starting materials of the composite oxide might not be melted, resulting in insufficient diffusion. Then, there is a high possibility that the layered rock-salt crystal structure has a lot of defects or distortions. As a result, the pseudo-spinel crystal structure after high-voltage charging also might have defects or distortions.

Thus, it is preferable that a composite oxide having a layered rock-salt crystal structure with few impurities, defects, or distortions be obtained first. Then, the composite oxide, the magnesium source, and the fluorine source are preferably mixed and annealed in a later step to form a solid solution of magnesium and fluorine in the surface portion of the composite oxide. In this matter, the positive electrode active material having the pseudo-spinel crystal structure with few defects or distortions after high-voltage charging can be formed.

This embodiment can be implemented in appropriate combination with any of the other embodiments.

### Embodiment 4

In this embodiment, examples of materials that can be used for a secondary battery containing the positive electrode active material 100 described in the above embodiment are described. In this embodiment, a secondary battery in which a positive electrode, a negative electrode, and an electrolyte solution are wrapped in an exterior body is described as an example.

### [Positive Electrode]

The positive electrode includes a positive electrode active material layer and a positive electrode current collector.

### <Positive Electrode Active Material Layer>

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material 100 described in the above embodiment can be used. A secondary battery including the positive electrode active material 100 described in the above embodiment can have high capacity and excellent cycle performance.

Examples of the conductive additive include a carbon material, a metal material, and a conductive ceramic material. Alternatively, a fiber material may be used as the conductive additive. The content of the conductive additive in the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive additive. The conductive additive also allows the maintenance of a path for electric conduction between the positive electrode active material particles. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Furthermore, as carbon fiber, carbon nanofiber and carbon nanotube can be used. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. Furthermore, a graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Thus, a graphene compound is preferably used as the conductive additive, in which case the area where the active material and the conductive additive are in contact with each other can be increased. The graphene compound serving as the conductive additive is preferably formed with a spray dry apparatus as a coating film to cover the entire surface of the active material, in which case the electrical resistance can be reduced in some cases. Here, it is particularly preferable to use, for example, graphene, multi graphene, or RGO as a graphene compound. Note that RGO refers to a compound obtained by reducing graphene oxide (GO), for example.

In the case where an active material with a small particle diameter of 1 μm or less, for example, is used, the specific surface area of the active material is large and thus more conductive paths for connecting the active material particles are needed. Thus, the amount of the conductive additive tends to increase and the carried amount of the active material tends to decrease relatively. When the carried amount of the active material decreases, the capacity of the secondary battery also decreases. In such a case, a graphene compound that can efficiently form a conductive path even with a small amount is particularly preferably used as the conductive additive because the carried amount of the active material does not decrease.

A cross-sectional structure example of an active material layer 200 containing a graphene compound as a conductive additive is described below.

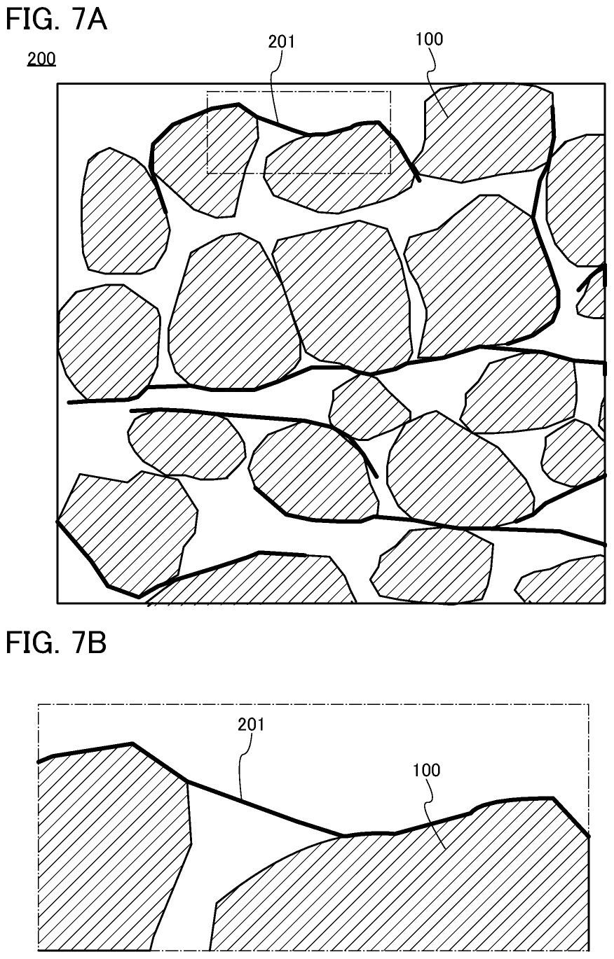

FIG. 7A is a longitudinal cross-sectional view of the active material layer 200. The active material layer 200 includes particles of the positive electrode active material 100, a graphene compound 201 serving as a conductive additive, and a binder (not illustrated). Here, graphene or multi graphene may be used as the graphene compound 201, for example. The graphene compound 201 preferably has a sheet-like shape. The graphene compound 201 may have a sheet-like shape formed of a plurality of sheets of multi graphene and/or a plurality of sheets of graphene that partly overlap with each other.

The longitudinal cross section of the active material layer 200 in FIG. 7B shows substantially uniform dispersion of the sheet-like graphene compounds 201 in the active material layer 200. The graphene compounds 201 are schematically shown by thick lines in FIG. 7B but are actually thin films each having a thickness corresponding to the thickness of a single layer or a multi-layer of carbon molecules. The plurality of graphene compounds 201 are formed to partly coat or adhere to the surfaces of the plurality of particles of the positive electrode active material 100, so that the graphene compounds 201 make surface contact with the particles of the positive electrode active material 100.

Here, the plurality of graphene compounds are bonded to each other to form a net-like graphene compound sheet (hereinafter, referred to as a graphene compound net or a graphene net). The graphene net covering the active material can function as a binder for bonding active materials. The amount of binder can thus be reduced, or the binder does not have to be used. This can increase the proportion of the active material in the electrode volume or weight. That is to say, the capacity of the secondary battery can be increased.

Here, it is preferable to perform reduction after a layer to be the active material layer 200 is formed in such a manner that graphene oxide is used as the graphene compound 201 and mixed with the active material. When graphene oxide with extremely high dispersibility in a polar solvent is used for the formation of the graphene compounds 201, the graphene compounds 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced either by heat treatment or with the use of a reducing agent, for example.

Unlike conductive additive particles that make point contact with an active material, such as acetylene black, the graphene compound 201 is capable of making low-resistance surface contact; accordingly, the electrical conduction between the particles of the positive electrode active material 100 and the graphene compounds 201 can be improved with a smaller amount of the graphene compound 201 than that of a normal conductive additive. This increases the proportion of the positive electrode active material 100 in the active material layer 200, resulting in increased discharge capacity of the secondary battery.

It is possible to form, with a spray dry apparatus, a graphene compound serving as a conductive additive as a coating film to cover the entire surface of the active material in advance and to form a conductive path between the active materials using the graphene compound.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

For the binder, for example, water-soluble polymers are preferably used. As the water-soluble polymers, for example, a polysaccharide can be used. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferred that such water-soluble polymers be used in combination with any of the above rubber materials.

Alternatively, as the binder, a material such as polystyrene, poly(methyl acrylate), poly(methyl methacrylate) (polymethyl methacrylate, PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having a significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

A fluorine-based resin has advantages such as excellent mechanical strength, high resistance to chemicals, and high heat resistance. PVDF, which is one of fluorine-based resins, has extremely excellent properties among the fluorine-based resins; it has high mechanical strength, excellent processability, and high heat resistance.

Meanwhile, when the slurry formed in coating the active material layer is alkaline, PVDF might be gelled. Alternatively, PVDF might become insoluble. Gelation or insolubilization of a binder might decrease adhesion between a current collector and an active material layer. In the case where the positive electrode active material of one embodiment of the present invention contains phosphorus, e.g., a phosphate compound, pH of the slurry can be reduced and gelation and insolubilization can be inhibited in some cases, which is preferable.

The thickness of the positive electrode active material layer is greater than or equal to 10 μm and less than or equal to 200 μm, for example. Alternatively, the thickness is greater than or equal to 50 μm and less than or equal to 150 μm. In the case where the positive electrode active material is a cobalt-containing material having a layered rock-salt crystal structure, the carried amount in the positive electrode active material layer is greater than or equal to 1 mg/cm² and less than or equal to 50 mg/cm², for example. Alternatively, the carried amount is greater than or equal to 5 mg/cm² and less than or equal to 30 mg/cm². In the case where the positive electrode active material is a cobalt-containing material having a layered rock-salt crystal structure, the density of the positive electrode active material layer is higher than or equal to 2.2 g/cm³ and lower than or equal to 4.9 g/cm³, for example. Alternatively, the density is higher than or equal to 3.8 g/cm³ and lower than or equal to 4.5 g/cm³.

### <Positive Electrode Current Collector>

The positive electrode current collector can be formed using a material that has high conductivity, such as a metal like stainless steel, gold, platinum, aluminum, and titanium, or an alloy thereof. It is preferred that a material used for the positive electrode current collector not dissolve at the potential of the positive electrode. Alternatively, the positive electrode current collector can be formed using an aluminum alloy to which an element that improves heat resistance, such as silicon, titanium, neodymium, scandium, or molybdenum, is added. Still alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

### [Negative Electrode]

The negative electrode includes a negative electrode active material layer and a negative electrode current collector. The negative electrode active material layer may contain a conductive additive and a binder.

### <Negative Electrode Active Material>

As a negative electrode active material, for example, an alloy-based material or a carbon-based material can be used.

For the negative electrode active material, an element that enables charge-discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by an alloying reaction and a dealloying reaction with lithium and a compound containing the element, for example, may be referred to as an alloy-based material.

In this specification and the like, SiO refers to, for example, silicon monoxide. Note that SiO can alternatively be expressed as SiOₓ. Here, x preferably has an approximate value of 1. For example, x is preferably 0.2 or more and 1.5 or less, further preferably 0.3 or more and 1.2 or less.

As the carbon-based material, graphite, graphitizing carbon (soft carbon), non-graphitizing carbon (hard carbon), carbon nanotube, graphene, carbon black, or the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector can be used. Note that a material which is not alloyed with carrier ions such as lithium is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains a small amount of dust particles and elements other than the constituent elements of the electrolyte solution (hereinafter, also simply referred to as impurities). Specifically, the weight ratio of impurities to the electrolyte solution is less than or equal to 1%, preferably less than or equal to 0.1%, and further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in charge and discharge at high voltage can be suppressed and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

### [Charging and Discharging Methods]

The secondary battery can be charged and discharged in the following manner, for example.

### «CC Charging»

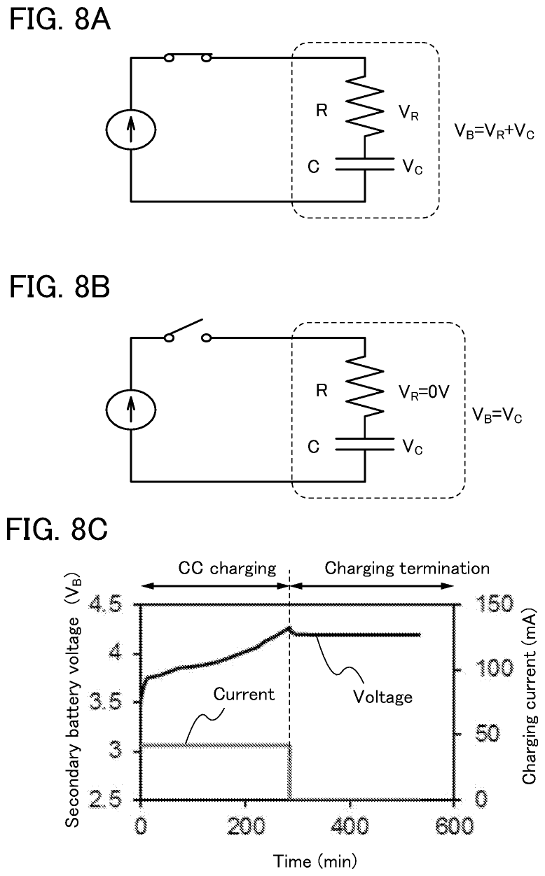

First, CC charging, which is one of charging methods, is described. CC charging is a charging method in which a constant current is made to flow to a secondary battery in the whole charge period and charging is terminated when the voltage reaches a predetermined voltage. The secondary battery is assumed to be an equivalent circuit with internal resistance R and secondary battery capacitance C as illustrated in FIG. 8A. In that case, a secondary battery voltage V_{B} is the sum of a voltage V_{R} applied to the internal resistance R and a voltage V_{C} applied to the secondary battery capacitance C.

While the CC charging is performed, a switch is on as illustrated in FIG. 8A, so that a constant current I flows to the secondary battery. During the period, the current I is constant; thus, in accordance with the Ohm's law V_{R}=R×I, the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, the charging is terminated. On termination of the CC charging, the switch is turned off as illustrated in FIG. 8B, and the current I becomes 0. Thus, the voltage V_{R} applied to the internal resistance R becomes 0 V. Consequently, the secondary battery voltage V_{B} is decreased.

FIG. 8C shows an example of the secondary battery voltage V_{B} and charge current during a period in which the CC charging is performed and after the CC charging is terminated. The secondary battery voltage V_{B} increases while the CC charging is performed, and slightly decreases after the CC charging is terminated.

### «CCCV Charging»

Next, CCCV charging, which is a charging method different from the above-described method, is described. CCCV charging is a charging method in which CC charging is performed until the voltage reaches a predetermined voltage and then CV (constant voltage) charging is performed until the amount of current flow becomes small, specifically, a termination current value.

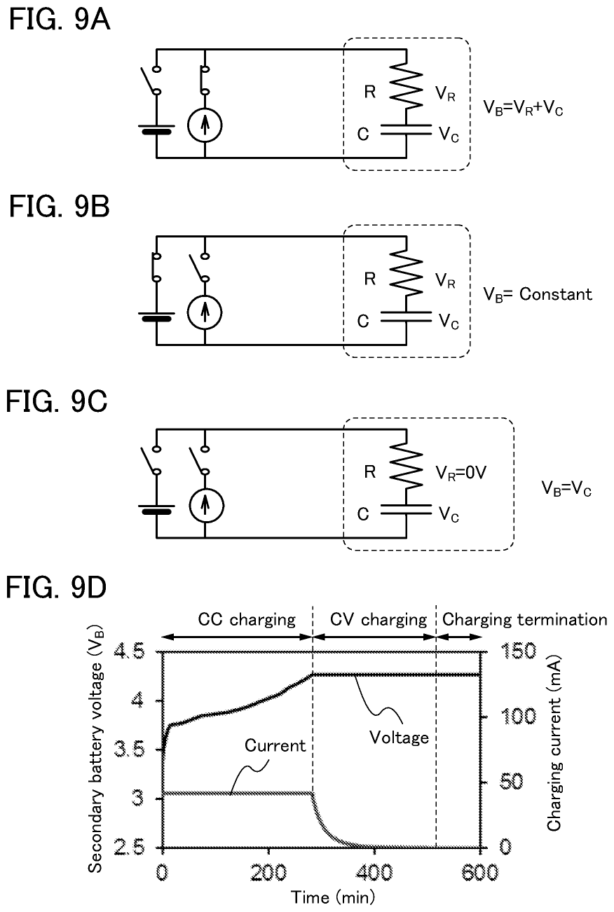

While the CC charging is performed, a switch of a constant current power source is on and a switch of a constant voltage power source is off as illustrated in FIG. 9A, so that the constant current I flows to the secondary battery. During the period, the current I is constant; thus, in accordance with the Ohm's law V_{R}=R×I, the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, switching is performed from the CC charging to the CV charging. While the CV charging is performed, the switch of the constant voltage power source is on and the switch of the constant current power source is off as illustrated in FIG. 9B; thus, the secondary battery voltage V_{B} is constant. In contrast, the voltage V_{C} applied to the secondary battery capacitance C increases over time. Since V_{B}=V_{R}+V_{C} is satisfied, the voltage V_{R} applied to the internal resistance R decreases over time. As the voltage V_{R} applied to the internal resistance R decreases, the current I flowing to the secondary battery also decreases in accordance with the Ohm's law V_{R}=R×I.

When the current I flowing to the secondary battery becomes a predetermined current, e.g., approximately 0.01 C, the charging is terminated. On termination of the CCCV charging, all the switches are turned off as illustrated in FIG. 9C, so that the current I becomes 0. Thus, the voltage V_{R} applied to the internal resistance R becomes 0 V. However, the voltage V_{R} applied to the internal resistance R becomes sufficiently small by the CV charging; thus, even when a voltage drop no longer occurs in the internal resistance R, the secondary battery voltage V_{B} hardly decreases.

FIG. 9D shows an example of the secondary battery voltage V_{B} and charge current while the CCCV charging is performed and after the CCCV charging is terminated. Even after the CCCV charging is terminated, the secondary battery voltage V_{B} hardly decreases.

### «CC Discharging»

Next, CC discharging, which is one of discharging methods, is described. CC discharging is a discharging method in which a constant current is made to flow from the secondary battery in the whole discharge period, and discharging is terminated when the secondary battery voltage V_{B} reaches a predetermined voltage, e.g., 2.5 V.

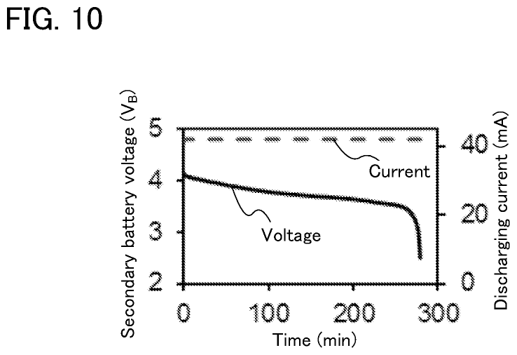

FIG. 10 shows an example of the secondary battery voltage V_{B} and discharge current while the CC discharging is performed. As the discharging proceeds, the secondary battery voltage V_{B} decreases.

Next, a discharge rate and a charge rate are described. The discharge rate refers to the relative ratio of discharge current to battery capacity and is expressed in a unit C. A current corresponding to 1 C in a battery with a rated capacity X (Ah) is X(A). The case where discharging is performed at a current of 2X(A) is rephrased as follows: discharging is performed at 2 C. The case where discharging is performed at a current of X/5(A) is rephrased as follows: discharging is performed at 0.2 C. Similarly, the case where charging is performed at a current of 2X(A) is rephrased as follows: charging is performed at 2 C, and the case where charging is performed at a current of X/5(A) is rephrased as follows: charging is performed at 0.2 C.

This embodiment can be implemented in appropriate combination with any of the other embodiments.

### Embodiment 5

In this embodiment, examples of the shape of a secondary battery including the positive electrode active material 100 described in the above embodiment are described. For the materials used for the secondary battery described in this embodiment, it is possible to refer to the description of the above embodiment.

### [Coin-Type Secondary Battery]

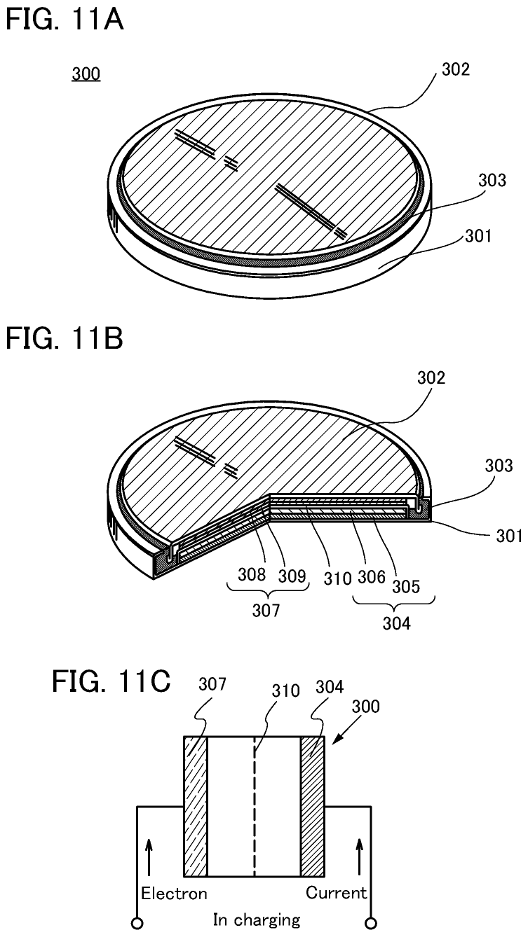

First, an example of a coin-type secondary battery is described. FIG. 11A is an external view of a coin-type (single-layer flat type) secondary battery, and FIG. 11B is a cross-sectional view thereof.

In a coin-type secondary battery 300, a positive electrode can 301 doubling as a positive electrode terminal and a negative electrode can 302 doubling as a negative electrode terminal are insulated and sealed by a gasket 303 formed of polypropylene or the like. A positive electrode 304 is formed of a positive electrode current collector 305 and a positive electrode active material layer 306 provided to be in contact with the positive electrode current collector 305. In addition, a negative electrode 307 is formed of a negative electrode current collector 308 and a negative electrode active material layer 309 provided to be in contact with the negative electrode current collector 308.

Note that an active material layer may be formed over only one surface of each of the positive electrode 304 and the negative electrode 307 used for the coin-type secondary battery 300.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel or the like) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte; as illustrated in FIG. 11B, the positive electrode 304, the separator 310, the negative electrode 307, and the negative electrode can 302 are stacked in this order with the positive electrode can 301 positioned at the bottom; and the positive electrode can 301 and the negative electrode can 302 are subjected to pressure bonding through the gasket 303 to manufacture the coin-type secondary battery 300.

With the use of the positive electrode active material described in the above embodiment for the positive electrode 304, the coin-type secondary battery 300 with high capacity and excellent cycle performance can be obtained.

Here, a current flow in charging a secondary battery is described using FIG. 11C. When a secondary battery using lithium is regarded as one closed circuit, movement of lithium ions and the current flow are in the same direction. Note that in the secondary battery using lithium, an anode and a cathode interchange in charging and discharging, and oxidation reaction and reduction reaction interchange; hence, an electrode with a high reaction potential is called a positive electrode and an electrode with a low reaction potential is called a negative electrode. For this reason, in this specification, the positive electrode is referred to as a “positive electrode” or a “+ electrode (plus electrode)” and the negative electrode is referred to as a “negative electrode” or a “− electrode (minus electrode)” in any of the case where charging is performed, the case where discharging is performed, the case where a pulse current in the reverse direction is made to flow in charging or discharging, and the case where charging current is made to flow. The use of terms an anode and a cathode related to oxidation reaction and reduction reaction might cause confusion because the anode and the cathode interchange in charging and in discharging. Thus, the terms the anode and the cathode are not used in this specification. If the term the anode or the cathode is used, it should be clearly mentioned that the anode or the cathode is which of the one in charging or in discharging and corresponds to which of the positive electrode (plus electrode) or the negative electrode (minus electrode)

A charger is connected to two terminals shown in FIG. 11C to charge the secondary battery 300. As the charging of the secondary battery 300 proceeds, a potential difference between the electrodes increases.

### [Cylindrical Secondary Battery]

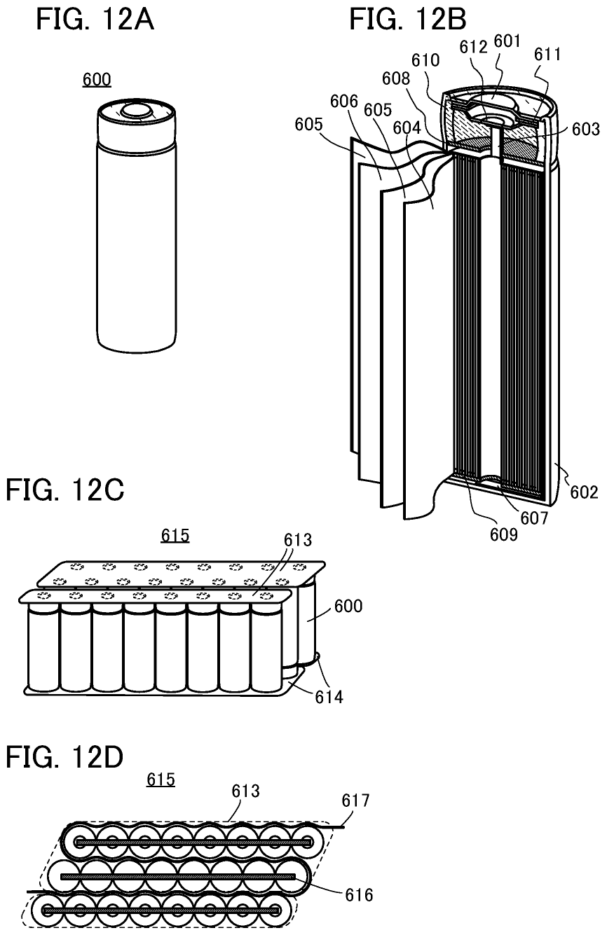

Next, an example of a cylindrical secondary battery is described with reference to FIG. 12. FIG. 12A is an external view of a cylindrical secondary battery 600. FIG. 12B is a diagram schematically illustrating a cross section of the cylindrical secondary battery 600. As illustrated in FIG. 12B, the cylindrical secondary battery 600 includes a positive electrode cap (battery lid) 601 on a top surface and a battery can (outer can) 602 on a side surface and a bottom surface. The positive electrode cap and the battery can (outer can) 602 are insulated by a gasket (insulating gasket) 610.

Inside the battery can 602 having a hollow cylindrical shape, a battery element in which a belt-like positive electrode 604 and a belt-like negative electrode 606 are wound with a separator 605 located therebetween is provided. Although not illustrated, the battery element is wound centering around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel or the like) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is sandwiched between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since the positive electrode and the negative electrode that are used for a cylindrical storage battery are wound, active materials are preferably formed on both surfaces of the current collector. A positive electrode terminal (positive electrode current collector lead) 603 is connected to the positive electrode 604, and a negative electrode terminal (negative electrode current collector lead) 607 is connected to the negative electrode 606. For both the positive electrode terminal 603 and the negative electrode terminal 607, a metal material such as aluminum can be used. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramic or the like can be used for the PTC element.

Alternatively, as illustrated in FIG. 12C, a plurality of secondary batteries 600 may be sandwiched between a conductive plate 613 and a conductive plate 614 to construct a module 615. The plurality of secondary batteries 600 may be connected in parallel, connected in series, or further connected in series after being connected in parallel. By constructing the module 615 including the plurality of secondary batteries 600, large power can be extracted.

FIG. 12D is a top view of the module 615. The conductive plate 613 is shown by a dotted line for clarity of the drawing. As illustrated in FIG. 12D, the module 615 may include a conducting wiring 616 that electrically connects the plurality of secondary batteries 600. It is possible to provide the conductive plate over the conducting wiring 616 to overlap. In addition, a temperature control device 617 may be included between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

With the use of the positive electrode active material described in the above embodiment for the positive electrode 604, the cylindrical secondary battery 600 with high capacity and excellent cycle performance can be obtained.

### [Structure Examples of Secondary Battery]

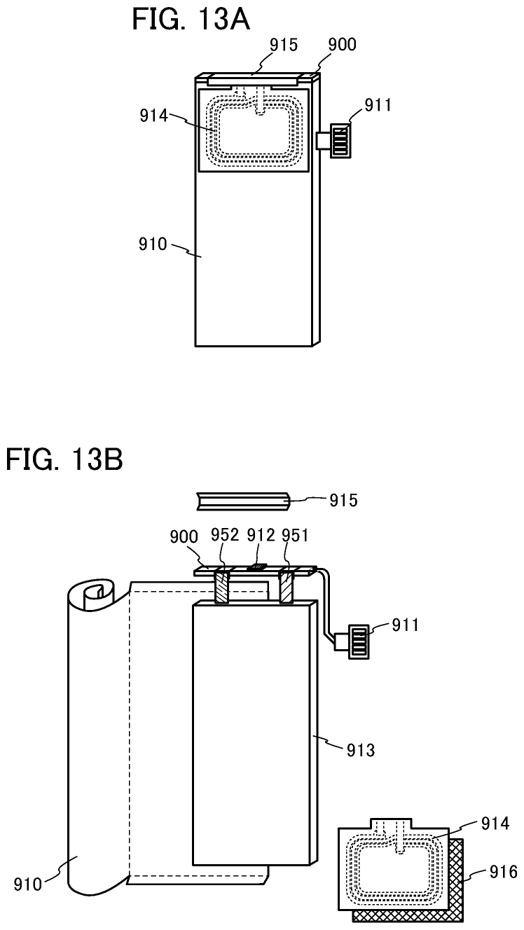

Other structure examples of a secondary battery are described using FIG. 13 to FIG. 17.

FIG. 13A and FIG. 13B are external views of a secondary battery. A secondary battery 913 is connected to an antenna 914 and an antenna 915 through a circuit board 900. A label 910 is attached to the secondary battery 913. Moreover, as illustrated in FIG. 13B, the secondary battery 913 is connected to a terminal 951 and a terminal 952.

The circuit board 900 includes a terminal 911 and a circuit 912. The terminal 911 is connected to the terminal 951, the terminal 952, the antenna 914, the antenna 915, and the circuit 912. Note that a plurality of terminals 911 serving as a control signal input terminal, a power supply terminal, and the like may be provided.

The circuit 912 may be provided on the rear surface of the circuit board 900. Note that the shapes of the antenna 914 and the antenna 915 are not limited to coil shapes, and may be linear shapes or plate shapes, for example. An antenna such as a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. This flat-plate conductor can serve as one of conductors for electric field coupling. That is, the antenna 914 or the antenna 915 may serve as one of the two conductors included in a capacitor. Thus, electric power can be transmitted and received not only by an electromagnetic field or a magnetic field but also by an electric field.

The line width of the antenna 914 is preferably larger than the line width of the antenna 915. This makes it possible to increase the amount of power received by the antenna 914.

The secondary battery includes a layer 916 between the secondary battery 913 and the antenna 914 and the antenna 915. The layer 916 has a function of blocking an electromagnetic field from the secondary battery 913, for example. As the layer 916, for example, a magnetic body can be used.

Note that the structure of the secondary battery is not limited to that in FIG. 13.

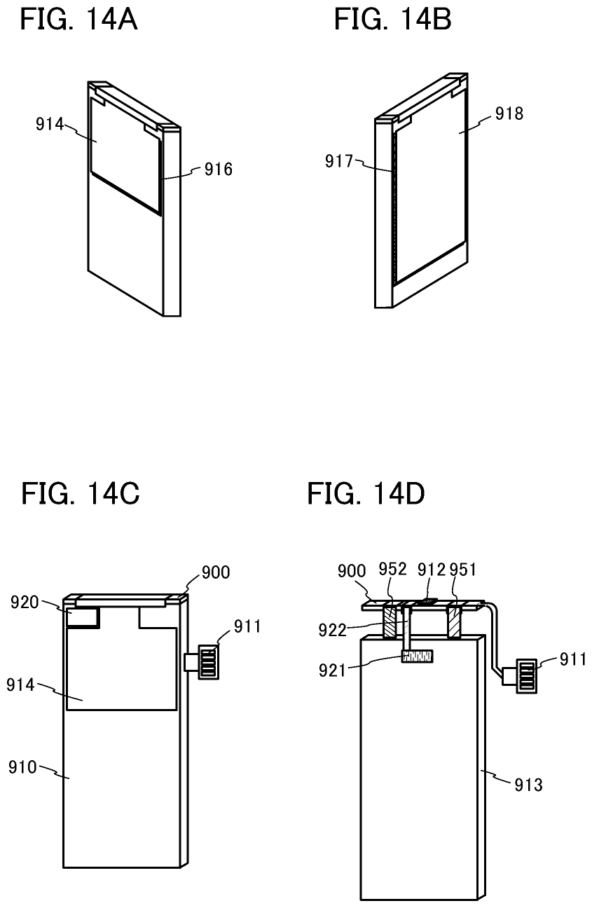

For example, as shown in FIG. 14A and FIG. 14B, an antenna may be provided for each of a pair of opposite surfaces of the secondary battery 913 shown in FIG. 13A and FIG. 13B. FIG. 14A is an external view illustrating one of the pair of surfaces, and FIG. 14B is an external view illustrating the other of the pair of surfaces. Note that, for the same portions as those in the secondary battery shown in FIG. 13A and FIG. 13B, it is possible to refer to the description of the secondary battery shown in FIG. 13A and FIG. 13B as appropriate.

As illustrated in FIG. 14A, the antenna 914 is provided on one of the opposite surfaces of the secondary battery 913 with the layer 916 located therebetween, and as illustrated in FIG. 14B, an antenna 918 is provided on the other of the opposite surfaces of the secondary battery 913 with a layer 917 located therebetween. The layer 917 has a function of blocking an electromagnetic field from the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be applied to the antenna 914, for example, can be applied to the antenna 918. As a system for communication using the antenna 918 between the secondary battery and another device, a response method that can be used between the secondary battery and another device, such as NFC (near field communication), can be employed.

Alternatively, as illustrated in FIG. 14C, the secondary battery 913 shown in FIG. 13A and FIG. 13B may be provided with a display device 920. The display device 920 is electrically connected to the terminal 911. Note that the label 910 is not necessarily provided in a portion where the display device 920 is provided. Note that for the same portions as those in the secondary battery shown in FIG. 13A and FIG. 13B, it is possible to refer to the description of the secondary battery shown in FIG. 13A and FIG. 13B as appropriate.

The display device 920 may display, for example, an image showing whether or not charging is being carried out, an image showing the amount of stored power, or the like. As the display device 920, electronic paper, a liquid crystal display device, an electroluminescence (also referred to as EL) display device, or the like can be used, for example. For example, the use of electronic paper can reduce power consumption of the display device 920.

Alternatively, as illustrated in FIG. 14D, the secondary battery 913 shown in FIG. 13A and FIG. 13B may be provided with a sensor 921. The sensor 921 is electrically connected to the terminal 911 via a terminal 922. For the same portions as those in the secondary battery shown in FIG. 13A and FIG. 13B, it is possible to refer to the description of the secondary battery shown in FIG. 13A and FIG. 13B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, power, radiation, flow rate, humidity, gradient, vibration, odor, or infrared rays. With provision of the sensor 921, for example, data on an environment where the secondary battery is placed (e.g., temperature or the like) can be detected and stored in a memory inside the circuit 912.

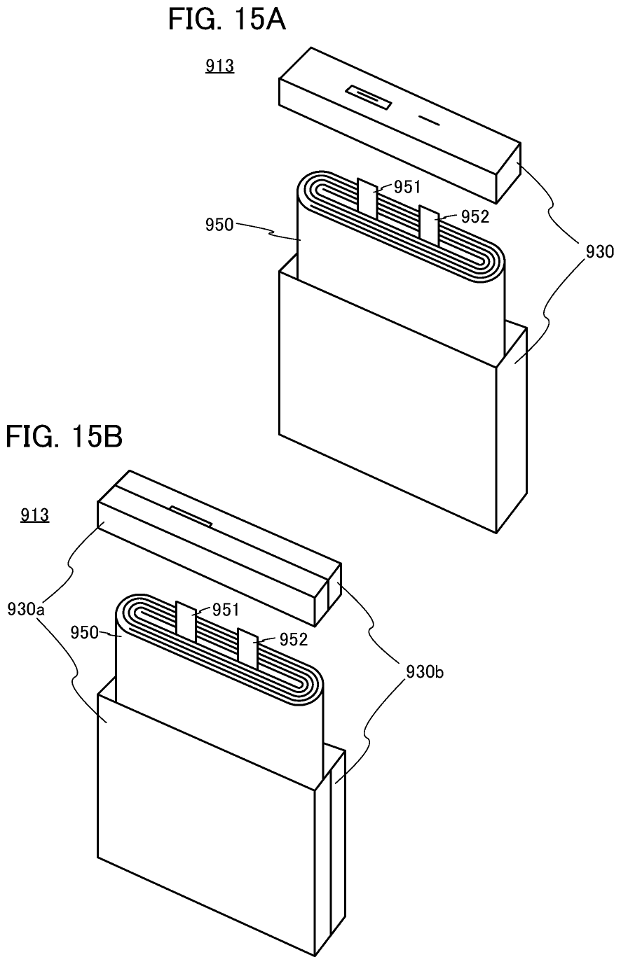

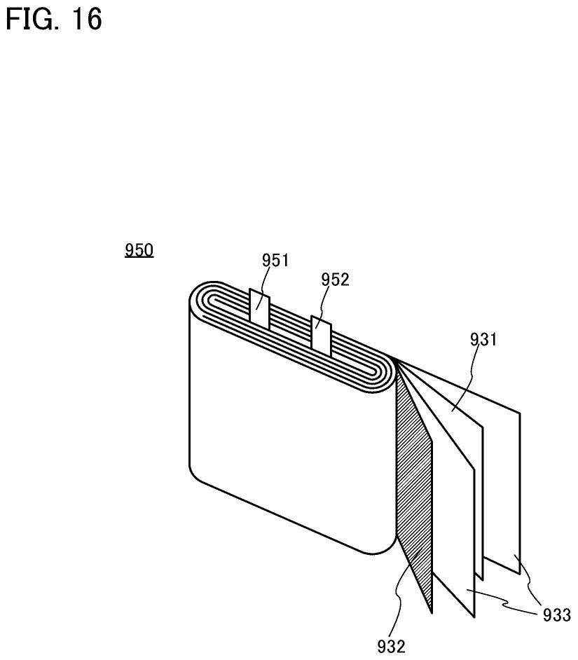

Furthermore, structure examples of the secondary battery 913 are described using FIG. 15 and FIG. 16.

The secondary battery 913 illustrated in FIG. 15A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that in FIG. 15A, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum or the like) or a resin material can be used.

Note that as illustrated in FIG. 15B, the housing 930 illustrated in FIG. 15A may be formed using a plurality of materials. For example, in the secondary battery 913 illustrated in FIG. 15B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. Note that in the case where blocking of an electric field by the housing 930a is small, an antenna such as the antenna 914 or the antenna 915 may be provided inside the housing 930a. For the housing 930b, a metal material can be used, for example.

In addition, FIG. 16 illustrates the structure of the wound body 950. The wound body 950 includes a negative electrode 931, a positive electrode 932, and separators 933. The wound body 950 is a wound body where the negative electrode 931 is stacked to overlap with the positive electrode 932 with the separator 933 sandwiched therebetween and the sheet of the stack is wound. Note that a plurality of stacks of the negative electrode 931, the positive electrode 932, and the separator 933 may be superimposed.

The negative electrode 931 is connected to the terminal 911 illustrated in FIG. 13 via one of the terminal 951 and the terminal 952. The positive electrode 932 is connected to the terminal 911 illustrated in FIG. 13 via the other of the terminal 951 and the terminal 952.

With the use of the positive electrode active material described in the above embodiment for the positive electrode 932, the secondary battery 913 with high capacity and excellent cycle performance can be obtained.

### [Laminated Secondary Battery]

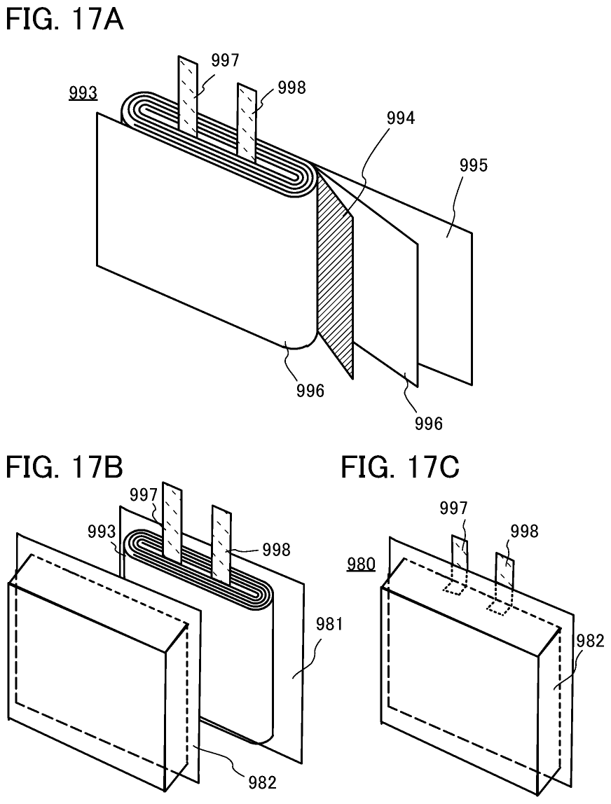

Next, examples of a laminated secondary battery are described with reference to FIG. 17 to FIG. 23. With a structure where the laminated secondary battery has flexibility and is incorporated in an electronic device at least part of which is flexible, the secondary battery can also be bent in accordance with the deformation of the electronic device.

A laminated secondary battery 980 is described using FIG. 17. The laminated secondary battery 980 includes a wound body 993 illustrated in FIG. 17A. The wound body 993 includes a negative electrode 994, a positive electrode 995, and separators 996. Like the wound body 950 illustrated in FIG. 16, the wound body 993 is a wound body where the negative electrode 994 is stacked to overlap with the positive electrode 995 with the separator 996 sandwiched therebetween and the sheet of the stack is wound.

Note that the number of stacked layers including the negative electrode 994, the positive electrode 995, and the separator 996 may be designed as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 17B, the wound body 993 is packed in a space formed through attachment of a film 981 serving as an exterior body and a film 982 having a depressed portion by thermocompression bonding or the like, whereby the secondary battery 980 illustrated in FIG. 17C can be formed. The wound body 993 includes the lead electrode 997 and the lead electrode 998, and is immersed in an electrolyte solution inside a space surrounded by the film 981 and the film 982 having a depressed portion.

For the film 981 and the film 982 having a depressed portion, a metal material such as aluminum or a resin material can be used, for example. With the use of a resin material as the material of the film 981 and the film 982 having a depressed portion, the film 981 and the film 982 having a depressed portion can be deformed when external force is applied; thus, a flexible storage battery can be manufactured.

In addition, although FIG. 17B and FIG. 17C illustrate an example of using two films, a space may be formed by bending one film and the wound body 993 may be packed in the space.

With the use of the positive electrode active material described in the above embodiment for the positive electrode 995, the secondary battery 980 with high capacity and excellent cycle performance can be obtained.

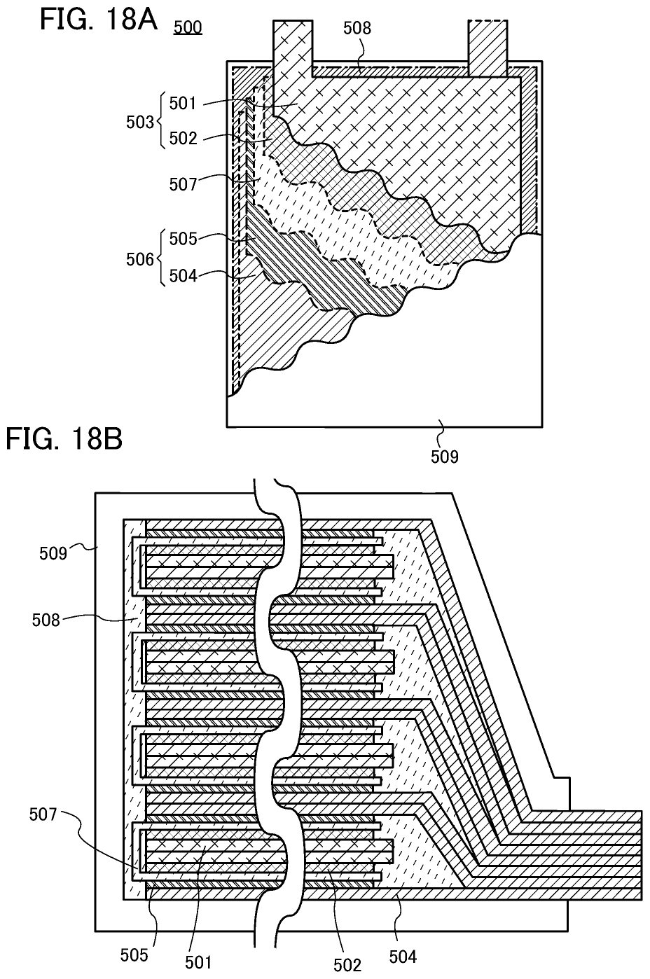

In addition, FIG. 17 illustrates an example in which the secondary battery 980 includes a wound body in a space formed by films serving as an exterior body; however, as illustrated in FIG. 18, for example, a secondary battery may include a plurality of strip-shaped positive electrodes, separators, and negative electrodes in a space formed by films serving as an exterior body.

A laminated secondary battery 500 illustrated in FIG. 18A includes a positive electrode 503 including a positive electrode current collector 501 and a positive electrode active material layer 502; a negative electrode 506 including a negative electrode current collector 504 and a negative electrode active material layer 505; a separator 507; an electrolyte solution 508; and an exterior body 509. The separator 507 is placed between the positive electrode 503 and the negative electrode 506 provided in the exterior body 509. In addition, the exterior body 509 is filled with the electrolyte solution 508. The electrolyte solution described in Embodiment 2 can be used as the electrolyte solution 508.

In the laminated secondary battery 500 illustrated in FIG. 18A, the positive electrode current collector 501 and the negative electrode current collector 504 also serve as terminals that make electrical contact with the outside. For this reason, parts of the positive electrode current collector 501 and the negative electrode current collector 504 may be arranged to be exposed from the exterior body 509 to the outside. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

In the laminated secondary battery 500, for the exterior body 509, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is further provided as the outer surface of the exterior body over the metal thin film can be used.

Furthermore, FIG. 18B illustrates an example of a cross-sectional structure of the laminated secondary battery 500. Although FIG. 18A illustrates an example in which the laminated secondary battery 500 is composed of two current collectors for simplicity, the laminated secondary battery 500 is actually composed of a plurality of electrode layers, as illustrated in FIG. 18B.

In FIG. 18B, the number of electrode layers is set to 16, for example. Note that the secondary battery 500 has flexibility even though the number of electrode layers is set to 16. FIG. 18B illustrates a structure including total 16 layers of eight layers of negative electrode current collectors 504 and eight layers of positive electrode current collectors 501. Note that FIG. 18B illustrates a cross section of the extraction portion of the negative electrode, and the eight layers of the negative electrode current collectors 504 are bonded by ultrasonic welding. It is needless to say that the number of electrode layers is not limited to 16, and may be either more than 16 or less than 16. In the case where the number of electrode layers is large, the secondary battery can have higher capacity. Moreover, in the case where the number of electrode layers is small, the secondary battery can have smaller thickness and high flexibility.

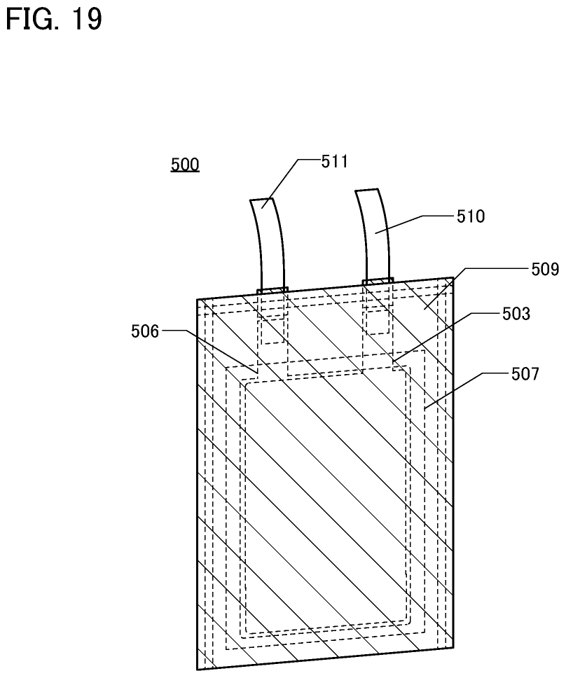

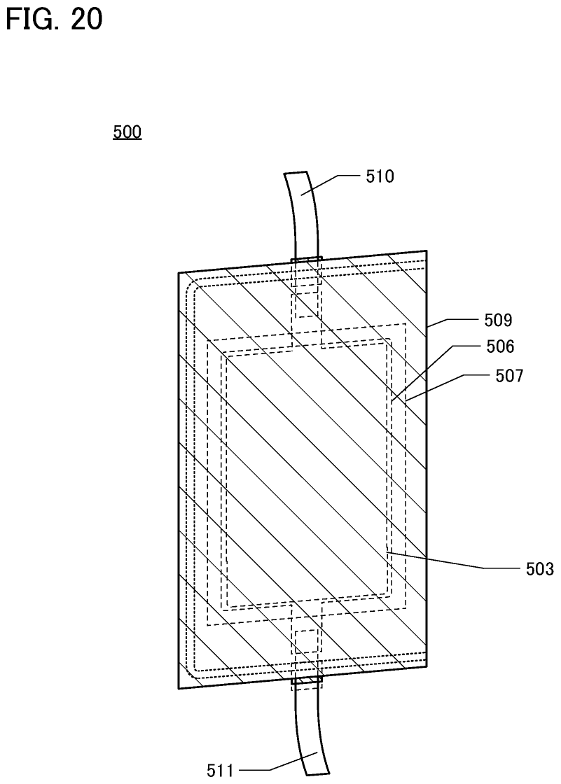

Here, FIG. 19 and FIG. 20 illustrate examples of the external view of the laminated secondary battery 500. In FIG. 19 and FIG. 20, the positive electrode 503, the negative electrode 506, the separator 507, the exterior body 509, a positive electrode lead electrode 510, and a negative electrode lead electrode 511 are included.

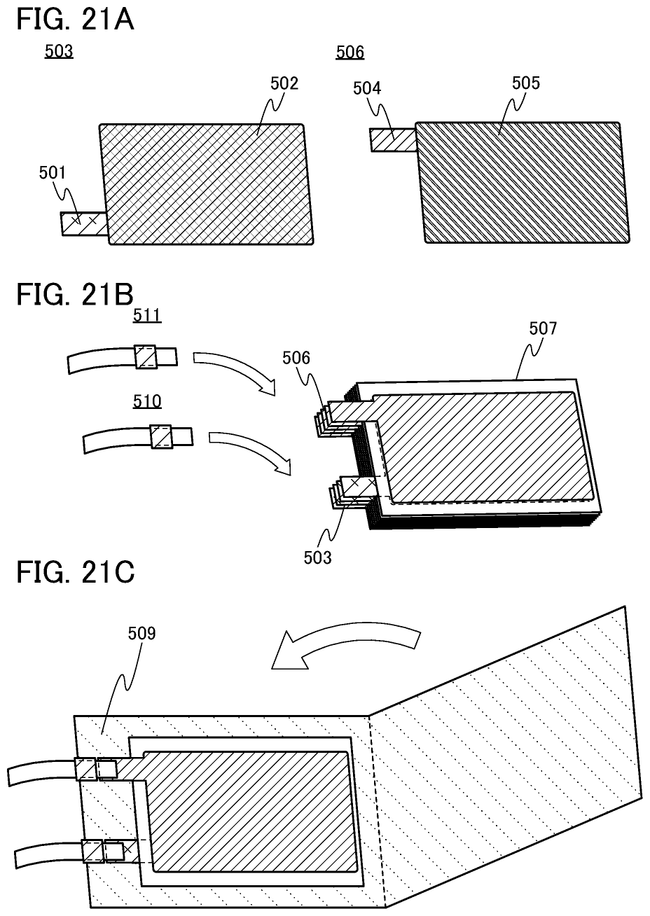

FIG. 21A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, such a region is referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and shapes of the tab regions included in the positive electrode and the negative electrode are not limited to the examples illustrated in FIG. 21A.

### [Manufacturing Method of Laminated Secondary Battery]

Here, an example of a manufacturing method of the laminated secondary battery whose external view is illustrated in FIG. 19 is described using FIG. 21B and FIG. 21C.

First, the negative electrode 506, the separator 507, and the positive electrode 503 are stacked. FIG. 21B illustrates the negative electrode 506, the separator 507, and the positive electrode 503 that are stacked. An example of using five sets of negative electrodes and four sets of positive electrodes is described here. Next, the tab regions of the positive electrodes 503 are bonded to each other, and the positive electrode lead electrode 510 is bonded to the tab region of the positive electrode on the outermost surface. Ultrasonic welding or the like may be used for the bonding, for example. In a similar manner, the tab regions of the negative electrodes 506 are bonded to each other, and the negative electrode lead electrode 511 is bonded to the tab region of the negative electrode on the outermost surface.

Next, the negative electrode 506, the separator 507, and the positive electrode 503 are placed over the exterior body 509.

Next, the exterior body 509 is bent along a portion shown by a dashed line, as illustrated in FIG. 21C. Then, the outer portions of the exterior body 509 are bonded. Thermocompression or the like may be used for the bonding, for example. At this time, an unbonded region (hereinafter referred to as an inlet) is provided for part (or one side) of the exterior body 509 so that the electrolyte solution 508 can be introduced later.

Next, the electrolyte solution 508 (not illustrated) is introduced into the inside of the exterior body 509 from the inlet provided for the exterior body 509. The electrolyte solution 508 is preferably introduced in a reduced pressure atmosphere or in an inert atmosphere. Lastly, the inlet is bonded. In this manner, the laminated secondary battery 500 can be manufactured.

With the use of the positive electrode active material described in the above embodiment for the positive electrode 503, the secondary battery 500 with high capacity and excellent cycle performance can be obtained.

### [Bendable Secondary Battery]

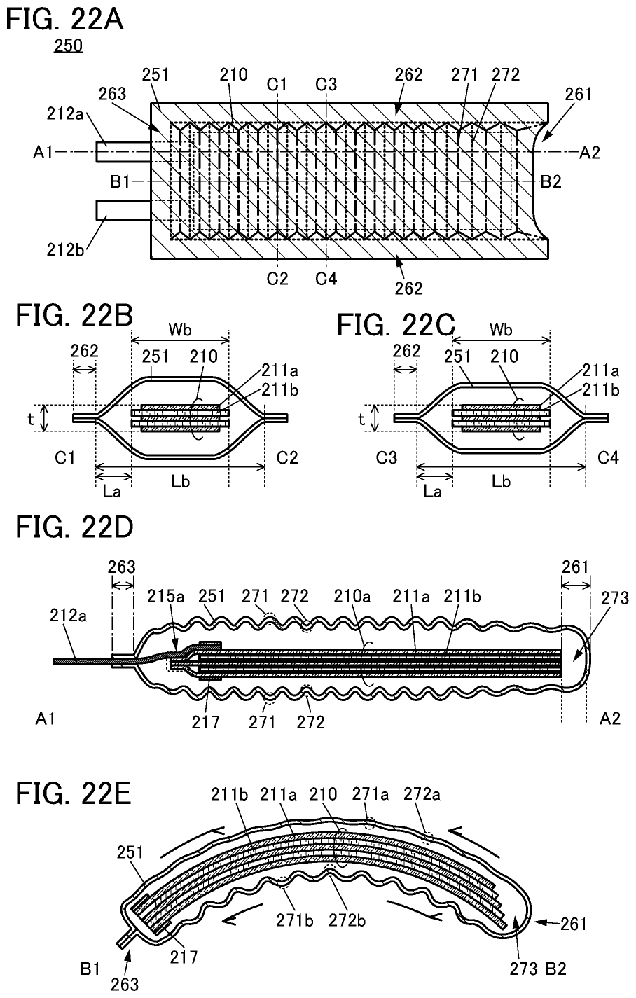

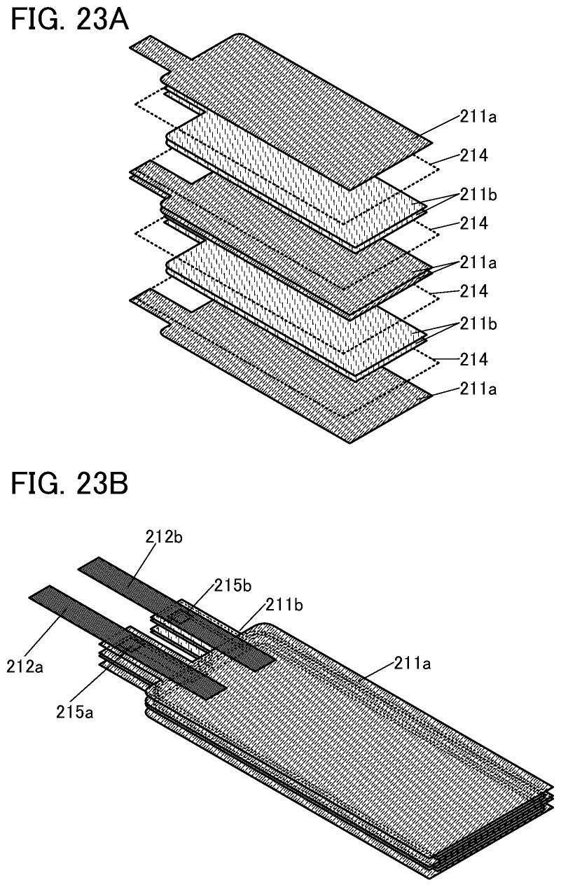

Next, an example of a bendable secondary battery is described with reference to FIG. 22 and FIG. 23.

FIG. 22A shows a schematic top view of a bendable secondary battery 250. FIG. 22B, FIG. 22C, and FIG. 22D are schematic cross-sectional views along cutting line C1-C2, cutting line C3-C4, and cutting line A1-A2, respectively, in FIG. 22A. The secondary battery 250 includes an exterior body 251, and a positive electrode 211a and a negative electrode 211b that are held in the inside of the exterior body 251. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

The positive electrode 211a and the negative electrode 211b that are included in the secondary battery 250 are described using FIG. 23. FIG. 23A is a perspective view illustrating the stacking order of the positive electrode 211a, the negative electrode 211b, and a separator 214. FIG. 23B is a perspective view illustrating the lead 212a and the lead 212b in addition to the positive electrode 211a and the negative electrode 211b.

As illustrated in FIG. 23A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab portion. A positive electrode active material layer is formed on a portion of one surface of the positive electrode 211a other than the tab portion, and a negative electrode active material layer is formed on a portion of one surface of the negative electrode 211b other than the tab portion.

The positive electrodes 211a and the negative electrodes 211b are stacked so that surfaces of the positive electrodes 211a where the positive electrode active material layers are not formed are in contact with each other and that surfaces of the negative electrodes 211b where the negative electrode active material are not formed are in contact with each other.

Furthermore, the separator 214 is provided between the surface of the positive electrode 211a on which the positive electrode active material is formed and the surface of the negative electrode 211b on which the negative electrode active material is formed. In FIG. 23, the separator 214 is shown by a dotted line for clarity.

In addition, as illustrated in FIG. 23B, the plurality of positive electrodes 211a are electrically connected to the lead 212a in a bonding portion 215a. Furthermore, the plurality of negative electrodes 211b are electrically connected to the lead 212b in a bonding portion 215b.

Next, the exterior body 251 is described using FIG. 22B, FIG. 22C, FIG. 22D, and FIG. 22E.

The exterior body 251 has a film-like shape and is folded in half with the positive electrodes 211a and the negative electrodes 211b between facing portions of the exterior body 251. The exterior body 251 includes a bent portion 261, a pair of seal portions 262, and a seal portion 263. The pair of seal portions 262 is provided with the positive electrodes 211a and the negative electrodes 211b positioned therebetween and thus can also be referred to as side seals. In addition, the seal portion 263 includes portions overlapping with the lead 212a and the lead 212b and can also be referred to as a top seal.

Portions of the exterior body 251 that overlap with the positive electrodes 211a and the negative electrodes 211b preferably have a wave shape in which crest lines 271 and trough lines 272 are alternately arranged. In addition, the seal portions 262 and the seal portion 263 of the exterior body 251 are preferably flat.

FIG. 22B is a cross section cut along a portion overlapping with the crest line 271. FIG. 22C is a cross section cut along a portion overlapping with the trough line 272. FIG. 22B and FIG. 22C both correspond to cross sections of the secondary battery 250, the positive electrodes 211a, and the negative electrodes 211b in the width direction.

Here, the distance between end portions of the positive electrode 211a and the negative electrode 211b in the width direction, that is, the end portions of the positive electrode 211a and the negative electrode 211b, and the seal portion 262, is referred to as a distance La. When the secondary battery 250 changes in shape, for example, is bent, the positive electrode 211a and the negative electrode 211b change in shape such that positions thereof are shifted from each other in the length direction as described later. At the time, if the distance La is too short, the exterior body 251, the positive electrode 211a, and the negative electrode 211b are rubbed hard, so that the exterior body 251 is damaged in some cases. In particular, when a metal film of the exterior body 251 is exposed, the metal film might be corroded by the electrolyte solution. Therefore, the distance La is preferably set as long as possible. On the other hand, if the distance La is too long, the volume of the secondary battery 250 is increased.

In addition, the distance La between the positive electrode 211a and the negative electrode 211b, and the seal portion 262 is preferably increased as the total thickness of the positive electrode 211a and the negative electrode 211b that are stacked is increased.

More specifically, when the total thickness of the positive electrode 211a and the negative electrode 211b that are stacked, and the separator 214 that is not illustrated is set to t, the distance La is 0.8 times or more and 3.0 times or less, preferably 0.9 times or more and 2.5 times or less, further preferably 1.0 time or more and 2.0 times or less as large as the thickness t. When the distance La is in this range, a compact battery that is highly reliable for bending can be achieved.

Furthermore, when the distance between the pair of seal portions 262 is set to a distance Lb, it is preferable that the distance Lb be sufficiently longer than the widths of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; thus, the positive electrode 211a and the negative electrode 211b can be effectively prevented from being rubbed against the exterior body 251.

For example, the difference between the distance Lb between the pair of seal portions 262 and the width Wb of the negative electrode 211b is 1.6 times or more and 6.0 times or less, preferably 1.8 times or more and 5.0 times or less, further preferably 2.0 times or more and 4.0 times or less as large as the thickness t of the positive electrode 211a and the negative electrode 211b.

In other words, the distance Lb, the width Wb, and the thickness t preferably satisfy the relationship of the following formula.

[Formula 3]

Lb−Wb/2t≥a (Formula 3)

Here, a satisfies 0.8 or more and 3.0 or less, preferably 0.9 or more and 2.5 or less, further preferably 1.0 or more and 2.0 or less.

FIG. 22D is a cross section including the lead 212a and corresponds to a cross section of the secondary battery 250, the positive electrode 211a, and the negative electrode 211b in the length direction. As illustrated in FIG. 22D, in the bent portion 261, a space 273 is preferably included between the end portions of the positive electrode 211a and the negative electrode 211b in the length direction and the exterior body 251.

FIG. 22E illustrates a schematic cross-sectional view when the secondary battery 250 is bent. FIG. 22E corresponds to a cross section along cutting line B1-B2 in FIG. 22A.

When the secondary battery 250 is bent, part of the exterior body 251 positioned on the outer side in bending is stretched and the other part positioned on the inner side in bending is deformed as it shrinks. More specifically, a portion of the exterior body 251 that is positioned on the outer side is deformed such that the wave amplitude becomes smaller and the wave period becomes longer. By contrast, a portion of the exterior body 251 that is positioned on the inner side is deformed such that the wave amplitude becomes larger and the wave period becomes shorter. When the exterior body 251 is deformed in this manner, stress applied to the exterior body 251 in accordance with bending is relieved, so that a material itself of the exterior body 251 does not need to expand and contract. As a result, the secondary battery 250 can be bent with weak force without damage to the exterior body 251.

Furthermore, as illustrated in FIG. 22E, when the secondary battery 250 is bent, the positive electrode 211a and the negative electrode 211b are shifted relatively to each other. At this time, ends of the stacked plurality of positive electrodes 211a and negative electrodes 211b on the seal portion 263 side are fixed by a fixing member 217. Thus, each of the plurality of positive electrodes 211a and negative electrodes 211b is shifted so that the shift amount becomes larger at a position closer to the bent portion 261. Therefore, stress applied to the positive electrodes 211a and the negative electrodes 211b is relieved, and the positive electrodes 211a and the negative electrodes 211b themselves do not need to expand and contract. Consequently, the secondary battery 250 can be bent without damage to the positive electrodes 211a and the negative electrodes 211b.

Furthermore, the space 273 is included between the positive electrode 211a and the negative electrode 211b, and the exterior body 251, whereby the positive electrode 211a and the negative electrode 211b can be shifted relatively while the positive electrode 211a and the negative electrode 211b located on an inner side in bending do not come in contact with the exterior body 251.

In the secondary battery 250 illustrated in FIG. 22 and FIG. 23, damage to the exterior body, damage to the positive electrode 211a and the negative electrode 211b, and the like are less likely to occur and battery characteristics are less likely to deteriorate even when the secondary battery 250 is repeatedly bent and stretched. With the use of the positive electrode active material described in the above embodiment for the positive electrode 211a included in the secondary battery 250, a battery with better cycle performance can be obtained.

This embodiment can be implemented in appropriate combination with any of the other embodiments.

### Embodiment 6

In this embodiment, examples of electronic devices each including the secondary battery of one embodiment of the present invention are described.

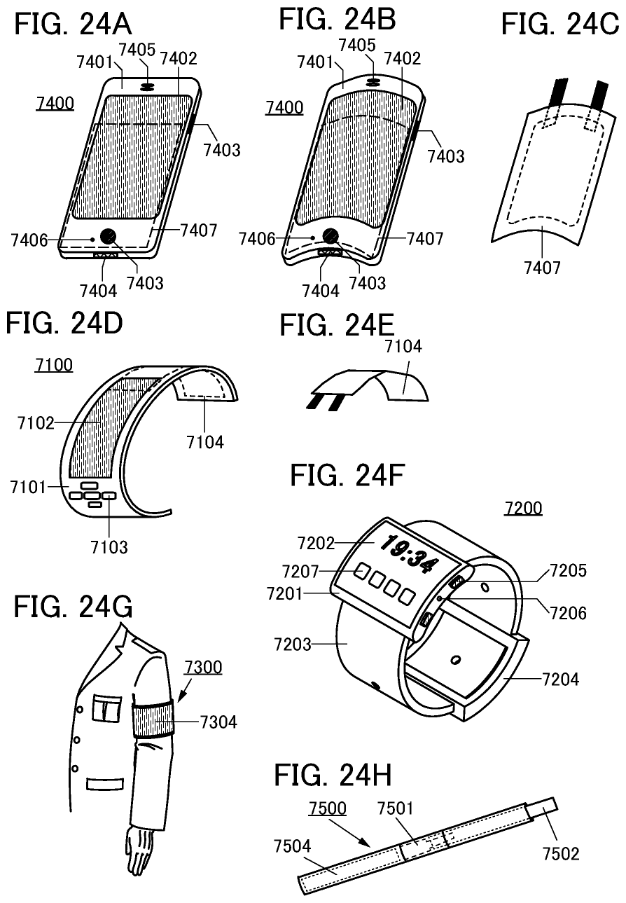

First, FIG. 24A to FIG. 24G show examples of electronic devices each including the bendable secondary battery described in part of Embodiment 3. Examples of electronic devices each including the bendable secondary battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, large game machines such as pachinko machines, and the like.

In addition, a secondary battery with a flexible shape can also be incorporated along a curved surface of an inside wall or an outside wall of a house or a building or an interior or an exterior of an automobile.

FIG. 24A illustrates an example of a mobile phone. A mobile phone 7400 includes operation buttons 7403, an external connection port 7404, a speaker 7405, a microphone 7406, and the like in addition to a display portion 7402 incorporated in a housing 7401. Note that the mobile phone 7400 includes a secondary battery 7407. With the use of the secondary battery of one embodiment of the present invention as the secondary battery 7407, a lightweight mobile phone with a long lifetime can be provided.

FIG. 24B illustrates the mobile phone 7400 in a bent state. When the whole mobile phone 7400 is bent through deformation by external force, the secondary battery 7407 provided therein is also bent. In addition, FIG. 24C illustrates the state of the bent secondary battery 7407 at this time. The secondary battery 7407 is a thin storage battery. The secondary battery 7407 is fixed in a state of being bent. Note that the secondary battery 7407 includes a lead electrode electrically connected to a current collector. A structure is employed in which the current collector is, for example, copper foil, and is partly alloyed with gallium to improve adhesion between the current collector and an active material layer in contact with the current collector, and the secondary battery 7407 has high reliability in a state of being bent.

FIG. 24D illustrates an example of a bangle-type display device. A portable display device 7100 includes a housing 7101, a display portion 7102, operation buttons 7103, and a secondary battery 7104. In addition, FIG. 24E illustrates the state of the bent secondary battery 7104. When the curved secondary battery 7104 is on a user's arm, the housing changes its form and the curvature of a part or the whole of the secondary battery 7104 is changed. Note that a value represented by the radius of a circle that corresponds to the bending condition of a curve at a given point is referred to as the radius of curvature, and the reciprocal of the radius of curvature is referred to as curvature. Specifically, the radius of curvature at part or the whole of the housing or the main surface of the secondary battery 7104 is changed in the range of 40 mm to 150 mm. When the radius of curvature at the main surface of the secondary battery 7104 is within the range of 40 mm to 150 mm, reliability can be kept high. With the use of the secondary battery of one embodiment of the present invention as the secondary battery 7104, a lightweight portable display device with a long lifetime can be provided.

FIG. 24F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and computer games.

The display surface of the display portion 7202 is provided while being bent, and display can be performed along the bent display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off operation, wireless communication on/off operation, execution and cancellation of a silent mode, and execution and cancellation of a power saving mode can be performed. For example, the functions of the operation button 7205 can also be set freely by an operating system incorporated in the portable information terminal 7200.

In addition, the portable information terminal 7200 can execute near field communication that is standardized communication. For example, hands-free calling is possible by mutual communication between the portable information terminal 7200 and a headset capable of wireless communication.

Moreover, the portable information terminal 7200 includes the input/output terminal 7206, and data can be directly transmitted to and received from another information terminal via a connector. In addition, charging via the input/output terminal 7206 is also possible. Note that charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight portable information terminal with a long lifetime can be provided. For example, the secondary battery 7104 illustrated in FIG. 24E that is in the state of being bent can be embedded inside the housing 7201. Alternatively, the secondary battery 7104 illustrated in FIG. 24E can be embedded inside the band 7203 so that the secondary battery 7104 is in the state of capable of being bent.

The portable information terminal 7200 preferably includes a sensor. As the sensor, for example, a human body sensor such as a fingerprint sensor, a pulse sensor, or a temperature sensor, a touch sensor, a pressure sensor, an acceleration sensor, or the like is preferably mounted.

FIG. 24G illustrates an example of an armband display device. A display device 7300 includes a display portion 7304 and the secondary battery of one embodiment of the present invention. In addition, the display device 7300 can further include a touch sensor in the display portion 7304 and can also serve as a portable information terminal.

The display surface of the display portion 7304 is bent, and display can be performed on the bent display surface. In addition, the display state of the display device 7300 can be changed by, for example, near field communication that is standardized communication, or the like.

In addition, the display device 7300 includes an input/output terminal, and data can be directly transmitted to and received from another information terminal via a connector. In addition, charging via the input/output terminal is also possible. Note that charging operation may be performed by wireless power feeding without using the input/output terminal.

With the use of the secondary battery of one embodiment of the present invention as the secondary battery included in the display device 7300, a lightweight display device with a long lifetime can be provided.

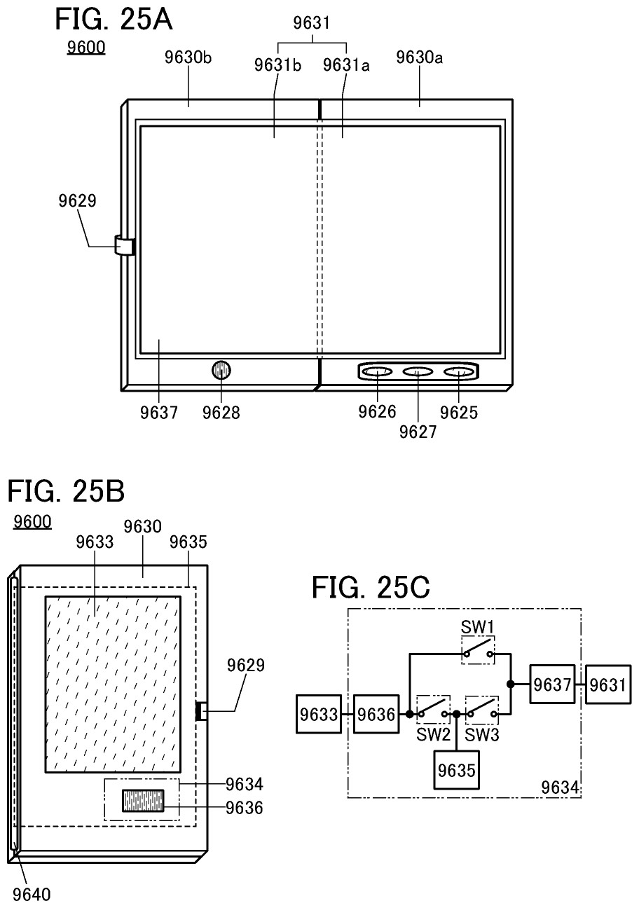

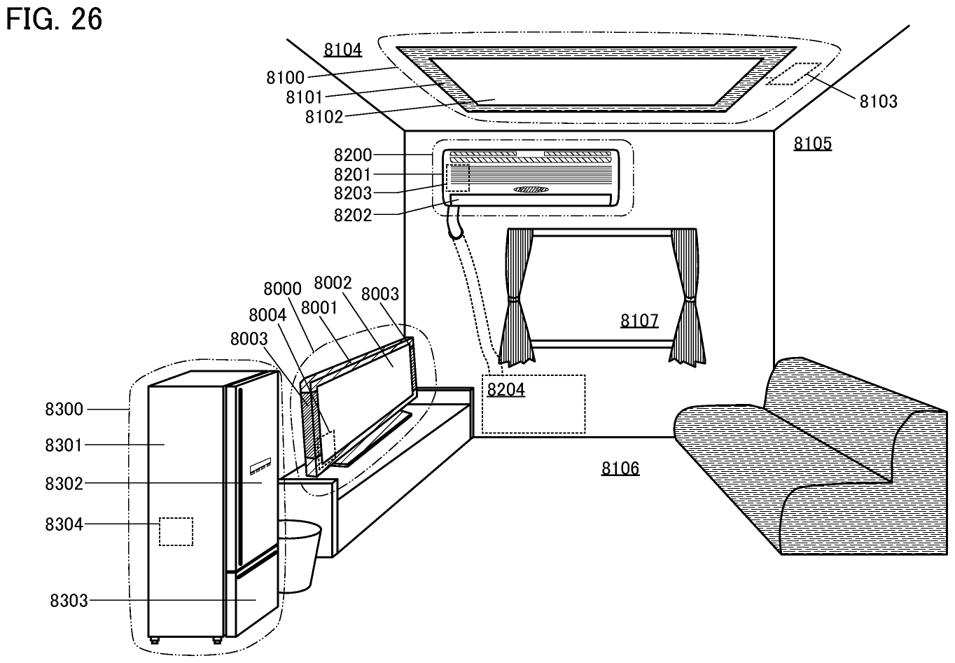

In addition, examples of electronic devices each including the secondary battery with excellent cycle performance described in the above embodiment are described using FIG. 24H, FIG. 25, and FIG. 26.

With the use of the secondary battery of one embodiment of the present invention as a secondary battery of a daily electronic device, a lightweight product with a long lifetime can be provided. Examples of the daily electronic device include an electric toothbrush, an electric shaver, electric beauty equipment, and the like. As secondary batteries of these products, small and lightweight secondary batteries with stick-like shapes and high capacity are desired in consideration of handling ease for users.

FIG. 24H is a perspective view of a device also called a cigarette smoking device (electronic cigarette). In FIG. 24H, an electronic cigarette 7500 is composed of an atomizer 7501 including a heating element, a secondary battery 7504 that supplies power to the atomizer, and a cartridge 7502 including a liquid supply bottle, a sensor, and the like. To increase safety, a protection circuit that prevents overcharge and overdischarge of the secondary battery 7504 may be electrically connected to the secondary battery 7504. The secondary battery 7504 illustrated in FIG. 24H includes an external terminal for connection to a charger. When the electronic cigarette 7500 is held, the secondary battery 7504 is a tip portion; thus, it is desirable that the secondary battery 7504 have a short total length and be lightweight. Since the secondary battery of one embodiment of the present invention has high capacity and excellent cycle performance, the small and lightweight electronic cigarette 7500 that can be used for a long time over a long period can be provided.

FIG. 25A and FIG. 25B show an example of a double-foldable tablet terminal. A tablet terminal 9600 illustrated in FIG. 25A and FIG. 25B includes a housing 9630a, a housing 9630b, a movable portion 9640 that connects the housing 9630a to the housing 9630b, a display portion 9631 that includes a display portion 9631a and a display portion 9631b, a switch 9625 to a switch 9627, a fastener 9629, and an operation switch 9628. When a flexible panel is used for the display portion 9631, a tablet terminal with a larger display portion can be provided. FIG. 25A shows the tablet terminal 9600 that is opened, and FIG. 25B shows the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching an image including an icon, text, an input form, or the like displayed on the region. For example, keyboard buttons may be displayed on the entire surface of the display portion 9631a on the housing 9630a side, and data such as text or an image may be displayed on the display portion 9631b on the housing 9630b side.

Alternatively, a keyboard may be displayed on the display portion 9631b on the housing 9630b side, and data such as text or an image may be displayed on the display portion 9631a on the housing 9630a side. Alternatively, a button for switching keyboard display on a touch panel may be displayed on the display portion 9631, and the button may be touched with a finger, a stylus, or the like to display a keyboard on the display portion 9631.

In addition, touch input can also be performed concurrently in a touch panel region in the display portion 9631a on the housing 9630a side and a touch panel region in the display portion 9631b on the housing 9630b side.

In addition, the switch 9625 to the switch 9627 may function not only as interfaces for operating the tablet terminal 9600 but also as interfaces that can switch various functions. For example, at least one of the switch 9625 to the switch 9627 may function as a switch for switching power on/off of the tablet terminal 9600. For another example, at least one of the switch 9625 to the switch 9627 may have a function of switching display between a portrait mode and a landscape mode or a function of switching display between monochrome display and color display. For another example, at least one of the switch 9625 to the switch 9627 may have a function of adjusting the luminance of the display portion 9631. Alternatively, the luminance of the display portion 9631 can be optimized in accordance with the amount of external light in use of the tablet terminal 9600, which is detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

In addition, FIG. 25A illustrates the example where the display portion 9631a on the housing 9630a side and the display portion 9631b on the housing 9630b side have substantially the same display area; however, there is no particular limitation on the display area of each of the display portion 9631a and the display portion 9631b, and one of the display portions may have a size different from that of the other of the display portions, and one of the display portions may have display quality different from that of the other of the display portions. For example, one may be a display panel that can display higher-definition images than the other.

The tablet terminal 9600 is folded in half in FIG. 25B. The tablet terminal 9600 includes a housing 9630, a solar cell 9633, and a charge and discharge control circuit 9634 including a DCDC converter 9636. In addition, a power storage unit of one embodiment of the present invention is used as the power storage unit 9635.

Note that as described above, the tablet terminal 9600 can be folded in half; thus, the tablet terminal 9600 can be folded such that the housing 9630a and the housing 9630b overlap with each other when not in use. The display portion 9631 can be protected owing to the folding, which increases the durability of the tablet terminal 9600. Since the power storage unit 9635 including the secondary battery of one embodiment of the present invention has high capacity and excellent cycle performance, the tablet terminal 9600 that can be used for a long time over a long period can be provided.

In addition, the tablet terminal 9600 illustrated in FIG. 25A and FIG. 25B can also have a function of displaying various kinds of data (a still image, a moving image, a text image, and the like), a function of displaying a calendar, a date, or time on the display portion, a touch-input function of operating or editing data displayed on the display portion by touch input, a function of controlling processing by a variety of software (programs), and the like.

With the solar cell 9633 that is attached onto the surface of the tablet terminal 9600, power can be supplied to a touch panel, a display portion, a video signal processing portion, and the like. Note that it is possible to obtain a structure where the solar cell 9633 can be provided on one surface or both surfaces of the housing 9630 and the power storage unit 9635 is charged efficiently. Note that the use of a lithium-ion battery as the power storage unit 9635 brings an advantage such as a reduction in size.

In addition, the structure and operation of the charge and discharge control circuit 9634 illustrated in FIG. 25B will be described using a block diagram in FIG. 25C. The solar cell 9633, the power storage unit 9635, the DCDC converter 9636, a converter 9637, switches SW1 to SW3, and the display portion 9631 are illustrated in FIG. 25C. The power storage unit 9635, the DCDC converter 9636, the converter 9637, and the switches SW1 to SW3 are portions that correspond to the charge and discharge control circuit 9634 illustrated in FIG. 25B.

First, an operation example when power is generated by the solar cell 9633 using external light is described. The voltage of power generated by the solar cell is raised or lowered by the DCDC converter 9636 to be a voltage for charging the power storage unit 9635. Then, when the power from the solar cell 9633 is used for the operation of the display portion 9631, the switch SW1 is turned on and the voltage of the power is raised or lowered by the converter 9637 to be a voltage needed for the display portion 9631. In addition, when display on the display portion 9631 is not performed, a structure where SW1 is turned off and SW2 is turned on to charge the power storage unit 9635 may be used.

Note that the solar cell 9633 is described as an example of a power generation means; however, there is no particular limitation on this example. A structure where the power storage unit 9635 is charged using another power generation means such as a piezoelectric element or a thermoelectric conversion element (Peltier element) may be used. For example, a structure where the power storage unit 9635 is charged with a non-contact power transmission module that transmits and receives power wirelessly (without contact) for charging, or with a combination of another charging means may be used.

FIG. 26 illustrates other examples of electronic devices. In FIG. 26, a display device 8000 is an example of an electronic device using a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided inside the housing 8001. The display device 8000 can be supplied with power from a commercial power supply, or the display device 8000 can use power stored in the secondary battery 8004. Thus, the display device 8000 can be utilized with the use of the secondary battery 8004 of one embodiment of the present invention as an uninterruptible power supply even when power cannot be supplied from a commercial power supply due to a power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes all of information display devices for personal computers, advertisement display, and the like besides information display devices for TV broadcast reception.

In FIG. 26, an installation lighting device 8100 is an example of an electronic device using a secondary battery 8103 of one embodiment of the present invention. Specifically, the lighting device 8100 includes a housing 8101, a light source 8102, the secondary battery 8103, and the like. Although FIG. 26 illustrates the case where the secondary battery 8103 is provided inside a ceiling 8104 on which the housing 8101 and the light source 8102 are installed, the secondary battery 8103 may be provided inside the housing 8101. The lighting device 8100 can be supplied with power from a commercial power supply, or the lighting device 8100 can use power stored in the secondary battery 8103. Thus, the lighting device 8100 can be utilized with the use of the secondary battery 8103 of one embodiment of the present invention as an uninterruptible power supply even when power cannot be supplied from a commercial power supply due to a power failure or the like.

Note that although the installation lighting device 8100 provided in the ceiling 8104 is illustrated in FIG. 26, the secondary battery of one embodiment of the present invention can be used for an installation lighting device provided in, for example, a wall 8105, a floor 8106, a window 8107, or the like other than the ceiling 8104, or can be used in a tabletop lighting device or the like.

In addition, an artificial light source that obtains light artificially by using power can be used as the light source 8102. Specifically, an incandescent lamp, a discharge lamp such as a fluorescent lamp, and light-emitting elements such as an LED and an organic EL element are given as examples of the artificial light source.

In FIG. 26, an air conditioner including an indoor unit 8200 and an outdoor unit 8204 is an example of an electronic device using a secondary battery 8203 of one embodiment of the present invention. Specifically, the indoor unit 8200 includes a housing 8201, an air outlet 8202, the secondary battery 8203, and the like. Although FIG. 26 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with power from a commercial power supply, or the air conditioner can use power stored in the secondary battery 8203. Particularly in the case where the secondary batteries 8203 are provided in both the indoor unit 8200 and the outdoor unit 8204, the air conditioner can be utilized with the use of the secondary batteries 8203 of one embodiment of the present invention as uninterruptible power supplies even when power cannot be supplied from a commercial power supply due to a power failure or the like.

Note that although the split-type air conditioner composed of the indoor unit and the outdoor unit is illustrated in FIG. 26, the secondary battery of one embodiment of the present invention can also be used in an integrated air conditioner in which one housing has the function of an indoor unit and the function of an outdoor unit.

In FIG. 26, an electric refrigerator-freezer 8300 is an example of an electronic device using a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided inside the housing 8301 in FIG. 26. The electric refrigerator-freezer 8300 can be supplied with power from a commercial power supply, or the electric refrigerator-freezer 8300 can use power stored in the secondary battery 8304. Thus, the electric refrigerator-freezer 8300 can be utilized with the use of the secondary battery 8304 of one embodiment of the present invention as an uninterruptible power supply even when power cannot be supplied from a commercial power supply due to a power failure or the like.

Note that among the electronic devices described above, a high-frequency heating device such as a microwave oven and an electronic device such as an electric rice cooker require high power in a short time. Therefore, the tripping of a breaker of a commercial power supply in use of an electronic device can be prevented by using the secondary battery of one embodiment of the present invention as an auxiliary power supply for supplying power which cannot be supplied enough by the commercial power supply.

In addition, in a time period when electronic devices are not used, particularly in a time period when the proportion of the amount of power that is actually used to the total amount of power that can be supplied from a commercial power supply (such a proportion is referred to as a usage rate of power) is low, power is stored in the secondary battery, whereby the increase in the usage rate of power can be inhibited in a time period other than the above time period. For example, in the case of the electric refrigerator-freezer 8300, power is stored in the secondary battery 8304 in night time when the temperature is low and the refrigerator door 8302 and the freezer door 8303 are not opened and closed. Moreover, in daytime when the temperature is high and the refrigerator door 8302 and the freezer door 8303 are opened and closed, the usage rate of power in daytime can be kept low by using the secondary battery 8304 as an auxiliary power supply.

According to one embodiment of the present invention, the cycle performance of the secondary battery can be made better and reliability can be improved. Furthermore, according to one embodiment of the present invention, a secondary battery with high capacity can be obtained; thus, the secondary battery itself can be made more compact and lightweight owing to the improvement in the characteristics of the secondary battery. Thus, the secondary battery of one embodiment of the present invention is incorporated in the electronic device described in this embodiment, whereby a more lightweight electronic device with a longer lifetime can be obtained.

This embodiment can be implemented in appropriate combination with any of the other embodiments.

### Embodiment 7

In this embodiment, examples of vehicles each including the secondary battery of one embodiment of the present invention are described.

By incorporating secondary batteries in vehicles, next-generation clean energy automobiles such as hybrid electric vehicles (HEV), electric vehicles (EV), and plug-in hybrid electric vehicles (PHEV) can be achieved.

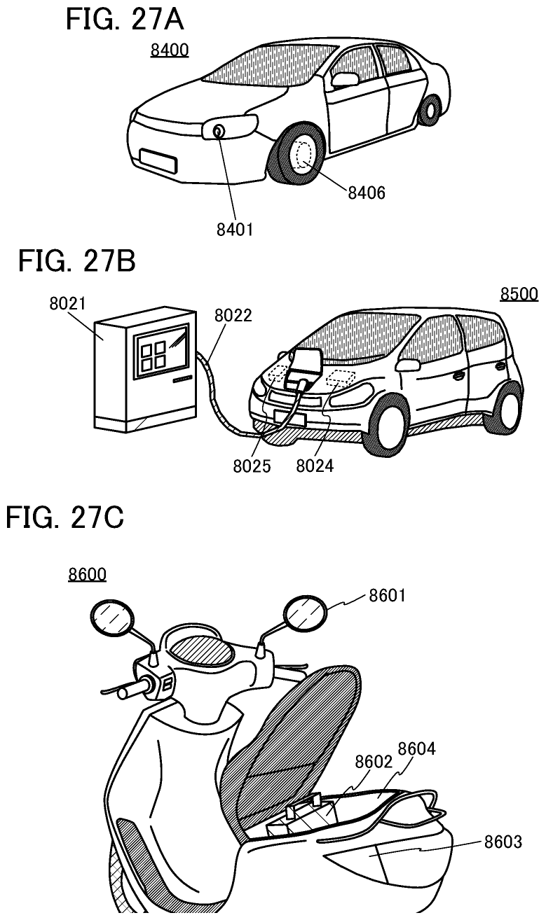

FIG. 27 illustrates examples of vehicles each using the secondary battery of one embodiment of the present invention. An automobile 8400 illustrated in FIG. 27A is an electric vehicle that runs on the power of an electric motor. Alternatively, the automobile 8400 is a hybrid electric vehicle capable of running on the power of either an electric motor or an engine as appropriate. The use of one embodiment of the present invention can achieve a vehicle with a wide cruising range. In addition, the automobile 8400 includes a secondary battery. As the secondary battery, the modules of the secondary batteries illustrated in FIG. 12C and FIG. 12D may be arranged to be used in a floor portion in the automobile. Alternatively, a battery pack in which a plurality of secondary batteries illustrated in FIG. 15 are combined may be placed in the floor portion in the automobile. The secondary battery not only drives an electric motor 8406 but also can supply power to a light-emitting device such as a headlight 8401 or a room light (not illustrated).

In addition, the secondary battery can supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 27B can be charged when a secondary battery included in the automobile 8500 is supplied with power from external charging equipment by a plug-in system, a contactless power feeding system, or the like. FIG. 27B illustrates a state where a secondary battery 8024 incorporated in the automobile 8500 is charged from a ground installation type charging device 8021 through a cable 8022. Charging may be performed as appropriate by a given method such as CHAdeMO (registered trademark) or Combined Charging System as a charging method, the standard of a connector, or the like. The charging device 8021 may be a charging station provided in a commerce facility or a power source in a house. For example, with a plug-in technique, the secondary battery 8024 incorporated in the automobile 8500 can be charged by power supply from the outside. Charging can be performed by converting AC power into DC power through a converter such as an ACDC converter.

Furthermore, although not illustrated, a power receiving device can be incorporated in a vehicle, and the vehicle can be charged by being supplied with power from an above-ground power transmitting device in a contactless manner. In the case of this contactless power feeding system, by incorporating a power transmitting device in a road or an exterior wall, charging can also be performed while the vehicle is driven without limitation on the period while the vehicle is stopped. In addition, this contactless power feeding system may be utilized to transmit and receive power between vehicles. Furthermore, a solar cell may be provided in the exterior of the vehicle to charge the secondary battery while the vehicle is stopped or while the vehicle is driven. For supply of power in such a contactless manner, an electromagnetic induction method or a magnetic resonance method can be used.

In addition, FIG. 27C is an example of a motorcycle using the secondary battery of one embodiment of the present invention. A motor scooter 8600 illustrated in FIG. 27C includes a secondary battery 8602, side mirrors 8601, and direction indicators 8603. The secondary battery 8602 can supply electricity to the direction indicators 8603.

Furthermore, in the motor scooter 8600 illustrated in FIG. 27C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 may be carried indoors when charged, and may be stored before the motor scooter is driven.

According to one embodiment of the present invention, the cycle performance of the secondary battery can be made better, and the capacity of the secondary battery can be increased. Thus, the secondary battery itself can be made more compact and lightweight. When the secondary battery itself can be made more compact and lightweight, it contributes to a reduction in the weight of a vehicle, and thus can improve the cruising range. Furthermore, the secondary battery incorporated in the vehicle can also be used as a power supply source for devices other than the vehicle. In that case, the use of a commercial power supply can be avoided at peak time of power demand, for example. Avoiding the use of a commercial power supply at peak time of power demand can contribute to energy saving and a reduction in carbon dioxide discharge. Moreover, with excellent cycle performance, the secondary battery can be used over a long period; thus, the use amount of rare metal including cobalt can be reduced.

This embodiment can be implemented in appropriate combination with any of the other embodiments.

### REFERENCE NUMERALS

100: positive electrode active material.

1. A positive electrode active material comprising lithium, cobalt, and an element X,
wherein a region represented by a layered rock-salt structure is included,
wherein a space group of the region is represented by R-3m,
wherein the element X is one or more selected from elements that have a property in which ΔE3 obtained by subtracting, from a stabilization energy in the case of substitution of the element at a lithium position in LiCoO₂, a stabilization energy before the substitution is smaller than ΔE4 obtained by subtracting, from a stabilization energy in the case of substitution of the element at a cobalt position in LiCoO₂, a stabilization energy before the substitution, and
wherein ΔE3 and ΔE4 are calculated by first-principles calculation.

2. The positive electrode active material according to claim 1,
wherein, in the first-principles calculation, the LiCoO₂ has a layered rock-salt structure, a space group is represented by R-3m, and ΔE3 is lower than or equal to 1 eV.

3. The positive electrode active material according to claim 1,
wherein the element X comprises one or more selected from calcium, magnesium, and zirconium.

4. A positive electrode active material comprising lithium, cobalt, nickel, manganese, and an element X,
wherein a region represented by a layered rock-salt structure is included,
wherein a space group of the region is represented by R-3m,
wherein the element X is one or more selected from elements that have a property in which ΔE5 obtained by subtracting, from a stabilization energy in the case of substitution of the element at a lithium position in LiCoₓNi_{y}Mn_{z}O₂, a stabilization energy before the substitution is smaller than ΔE6 that is the smallest value among values obtained by subtracting, from stabilization energies in the cases of substitution of the element at a cobalt position, at a nickel position, and a manganese position in LiCoₓNi_{y}Mn_{z}O₂, stabilization energies before the substitution,
wherein 0.8<x+y+z<1.2 is satisfied and y and z are each larger than 0.1 times x and smaller than eight times x, and
wherein ΔE5 and ΔE6 are calculated by first-principles calculation.

5. The positive electrode active material according to claim 4,
wherein, given that an atomic ratio of cobalt, nickel, and manganese contained in the positive electrode active material is X1:Y1:Z1, X1 is larger than 0.8 times x and smaller than 1.2 times x, Y1 is larger than 0.8 times y and smaller than 1.2 times y, and Z1 is larger than 0.8 times z and smaller than 1.2 times z.

6. The positive electrode active material according to claim 4,
wherein, in the first-principles calculation, the LiCoₓNi_{y}Mn_{z}O₂ has a layered rock-salt structure, a space group is represented by R-3m, and an absolute value of ΔE5 is lower than or equal to 1 eV.

7. A positive electrode active material comprising lithium, nickel, and an element X,
wherein a region represented by a layered rock-salt structure is included,
wherein a space group of the region is represented by R-3m,
wherein the element X is one or more selected from elements that have a property in which ΔE7 obtained by subtracting, from a stabilization energy in the case of substitution of the element at a lithium position in LiNiO₂, a stabilization energy before the substitution is smaller than ΔE8 obtained by subtracting, from a stabilization energy in the case of substitution of the element at a nickel position in LiCoₓNi_{y}Mn_{z}O₂, a stabilization energy before the substitution, and
wherein ΔE7 and ΔE8 are calculated by first-principles calculation.

8. The positive electrode active material according to claim 7,
wherein, in the first-principles calculation, the LiNiO₂ has a layered rock-salt structure, a space group is represented by R-3m, and ΔE7 is lower than or equal to 1 eV.

9. The positive electrode active material according to claim 1,
wherein, in the first-principles calculation, the element X is substituted at a lithium position or a cobalt position in a proportion of one atom or less of the element X to 54 oxygen atoms.

10. The positive electrode active material according to claim 1,
wherein, in the positive electrode active material, a concentration of the element X detected by X-ray photoelectron spectroscopy is greater than or equal to 0.4 and less than or equal to 1.5 when a sum of concentrations of cobalt, nickel, and manganese detected by X-ray photoelectron spectroscopy is 1.

11. The positive electrode active material according to claim 1, further comprising fluorine.

12. The positive electrode active material according to claim 1,
wherein the positive electrode active material comprises phosphorus, and
wherein, in the positive electrode active material, the number of phosphorus atoms is larger than or equal to 0.01 times a sum of the number of cobalt atoms, nickel atoms, and manganese atoms and smaller than or equal to 0.12 times the sum.

13. The positive electrode active material according to claim 1,
wherein the positive electrode active material has diffraction peaks at 2θ=19.30±0.20° and 2θ=45.55±0.10° when a secondary battery using the positive electrode active material for a positive electrode and a lithium metal for a negative electrode is subjected to constant current charging under 25° C. environment until battery voltage becomes 4.6 V and then subjected to constant voltage charging until a current value becomes 0.01 C, and then the positive electrode is analyzed by powder X-ray diffraction using a CuKα1 ray.

14. A secondary battery comprising a positive electrode in which a positive electrode active material layer comprising the positive electrode active material according to claim 1 is positioned over a current collector, and a negative electrode.

15. An electronic device comprising the secondary battery according to claim 14 and a display portion.

16. A vehicle comprising the secondary battery according to claim 14 and an electric motor.
